(19) United States
(12) Patent Application Publication
(10) Pub. No.: US 2006/0056791 A1
(43) Pub. Date: Mar. 16, 2006

(54) Arrangement for two-dimensional or three-dimensional representation

(76) Inventor: Wolfgang Tzschoppe, Jena-Rothenstein (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/533,342

(22) PCT Filed: Dec. 19, 2003
(86) PCT No.: PCT/EP03/14605

§ 371 Date: Apr. 29, 2005

(30) Foreign Application Priority Data
Dec. 20, 2002 (DE) 102 61 657.4
Apr. 11, 2003 (DE) 103 17 614.4

(51) Int. Cl. G02B 6/10

(52) U.S. Cl. 385/146

(57) ABSTRACT

An arrangement for two- or three-dimensional display including an image display device consisting of a multitude of light-transmitting image rendering elements, on which bits of image information from several perspective views can be displayed, and a wavelength filter array and a controllable illuminator providing at least two modes of operations. In a first mode of operation, light emitted by a first light source arranged behind the wavelength filter array reaches the observer by passing through at least part of the light-transmitting filter elements and subsequently through a correlated part of the image rendering elements of the image display device, so that the scene or object is seen by the observer in three dimensions. In a second mode of operation, light emitted by a second light source reaches the observer by passing through the image rendering elements of the image display device but not through the filter elements of the wavelength filter array, so that the scene or object is seen by the observer at least partially in two dimensions, with uniform illumination in the second mode of operation being provided by suitable means.

### FIELD OF THE INVENTION

The invention relates to an arrangement for two- or three-dimensional display.

### DESCRIPTION OF THE PRIOR ART

Many autostereoscopic display methods are based on the principle of the simultaneous optical rendering of several views of an object or scene with different perspectives, while using suitable means to make different selections of these perspective views visible to an observer's right and left eyes separately. This creates an effect of parallax, which allows the observer a spatial perception with distinct depth discrimination.

In the course of research in the field of autostereoscopic display, many methods and arrangements have been developed that give spatial impressions to one or several observers with unaided eyes. These arrangements often allow but a limited rendering of plain text or two-dimensional graphs; this is the case, for example, with U.S. Pat. No. 5,457,574 and U.S. Pat. No. 5,606,455. For users, however, it is of great advantage if they can switch over between 3D presentation visible with unaided eyes and high-resolution 2D presentation, with the least possible impairment, on one and the same device.

Among the devices used for the autostereoscopic optical rendering of an object's perspective views there are electronically controlled color LC displays, which, if controlled in the conventional way, are also capable of two-dimensional image rendition. In many applications there is a great interest for the user to be able to switch over from autostereoscopic spatial display (which, on account of its strong spatial impression is also called “Three-dimensional display” hereafter) to a two-dimensional display of the same scene or object. This is especially relevant for the readability of copy, which is rendered with better quality in the two-dimensional mode due to its higher image resolution.

With regard to switching over from 2D to 3D and vice versa, a number of arrangements are known.

WO 01/56265 of the present applicant, for example, describes a method of spatial display in which at least one wavelength filter array provides for a display that is perceived in three dimensions. In a special embodiment of this invention, an LC display acts as a wave-length filter array with variable transmittance that effects switching between 2D and 3D display. The downside is, though, that the light has to pass two LC displays, i.e., a great number of polarizing filters, color filters, liquid crystal layers and other elements such as carrier substrates, so that the brightness is diminished both in 2D and 3F presentation.

The WO 02/35277 describes a 3D display with a substrate containing stripes of certain optical properties and, in between, stripes of different optical properties, as well as a polarizer. This effects, among other things, 2D/3D switchover by means of polarization rotation, or adding/removal of a polarizer.

U.S. Pat. No. 6,157,424 describes a 2D/3D display in which two LC displays are arranged one behind the other, one of which acts as a barrier that can be switched on or off.

Another 2D/3D-switchable display is known from U.S. Pat. No. 6,337,721, which provides for several light sources, a lenticular and a functionally essential diffusion disk. These components ensure different illumination modes for creating a 2D or 3D presentation.

Known from U.S. Pat. No. 5,897,184 is an autostereoscopic display with a reduced-thickness illuminating component for portable computer systems, which permits zone-by-zone switching between 3D and 2D. The disadvantage is that this is a two-channel 3D display for a single observer, who needs to occupy a fixed viewing position. Moreover, image brightness in the 3D mode is lower than that delivered by comparable two-channel 3D displays (this means 3D displays that present exactly one left-hand and exactly one right-hand image). In addition, at viewing positions other than that at the correct depth in front of the 3D display, heavy, interfering moire effects are visible. In the 2D mode, the light available to the 3D mode is diffused with the aim to eliminate the 3D image separation by homogenizing the illumination. As a result, arrangements with a switchable diffusion disk provide an image brightness that is lower in the 2D mode than in the 3D mode, because such diffusion disks, in the diffusing state, have transmittances if smaller than 1. By the way, manufacturing the device calls for considerable process expenditure.

Further, U.S. Pat. No. 5,500,765 describes how the action of a lenticular can be eliminated by means of a complementary arrangement of lenslets hinged onto the lenticular. This, in effect, switches off the third dimension. Primarily, this approach only works with lenticular systems and requires the manufacture of an exactly complementary arrangement of lenslets.

DE 100 53 868 C2 of the present applicant describes an arrangement for selectable 2D or 3D display. The invention provides for two light sources; for total or partial 2D display, the 3D illuminant is either switched off or its light obstructed. As a disadvantage, the 2D illumination cannot be made to have sufficiently homogeneous luminance. Moreover, if a commercial optical waveguide is used for 2D illumination, its macroscopic structure is usually visible to the observer(s) and creates a disturbing pattern. To make an invisible, microscopic structure is laborious and expensive.

### DESCRIPTION OF THE INVENTION

Proceeding from the prior art as described, it is the objective of the invention simplify the switchability of the arrangement first mentioned above between a 3D mode, in which at least one, but preferably several observers see a spatial image with unaided eyes, and a 2D mode, and to improve the image quality, especially in the 3D mode. Further, the image quality in the 2D mode should not be essentially inferior to that of conventional 2D monitors, i.e., it should be possible for the observer(s) to see bright, fully resolved images. Optionally it should be possible to achieve greater image brightness in the 2D mode than in the 3D mode. Especially for the 2D mode, the illumination should be as homogeneous as possible, i.e. have a contrast that is close to zero. The arrangement should be dimensionable so as to provide sufficient space for the component used for 2D/3D switching, and it should be implemented, to the greatest possible extent, with commercially available components.

According to the invention, this problem is solved by an arrangement as described by the generic part and the characterizing part of claim 1.

Accordingly, a second light source is turned on in the second mode of operation for the purpose of 2D illumination. In addition, means are provided for uniform illumination, i.e. with the best possible homogeneity, in the second mode of operation.

The second light source may, for example, be a transparent plate made of a fluorescent material. This is irradiated laterally by, e.g., vertically arranged, thin, rod-shaped fluorescence lamps, which excite it to fluoresce.

In a preferred embodiment of the invention, the second light source is of planar shape and configured as an optical slab waveguide, which has two large surfaces arranged opposite to each other and surrounding narrow surfaces, and in which the large surface facing the image display device and/or away from it corresponds to the emission plane or the emission planes, and in which light is fed to the waveguide by one or several, laterally arranged light sources, the light being coupled into the waveguide through one or several of the narrow surfaces, partially reflected back and forth inside the waveguide by total reflection off the large surfaces, and partially coupled out through the large surface or surfaces corresponding to the emission plane or emission planes, respectively.

In a preferred embodiment of the invention that enables a bright and homogeneous illumination in the second mode of operation, the first light source is switched on in addition to the second one in the second mode of operation, only the large surface facing away from the image display device is intended as an emission plane, and only such areas in the emission plane are intended for uniform illumination that, in case of projection along the direction normal to the plane of the wavelength filter array, are essentially congruent with the areas covered by opaque filter elements. This means that the second light source emits light essentially in the places that correspond to the places covered by opaque filter elements.

Preferably, the two light sources are provided with dimming means, so that their brightness can be adapted to the ambient brightness.

The wavelength filter array is applied, for example, on the large surface corresponding to the emission plane. The term “array” in this context means any regular arrangement of filter elements, i.e. not only grid-like but also stripe-like arrangements, in which the stripes may be arranged in a vertical direction or in directions greatly deviating from the vertical, as long as three-dimensional observation in the first mode of operation is still possible. Equivalently and in addition to filter elements transparent and opaque to visible light, the array may also include grey-level filter elements and polarizing filters.

Further, the large surface corresponding to the emission plane may be coated with a structure that interferes with total reflection in the areas intended for emission. This structure may, for example, consist of particles. Preferably, the interfering capability of the particles is, between two limit levels, inhomogeneous across the extension of the emission plane, the limit levels depending on the particle density in the coating. The interfering capability of the particles may further be essentially constant within each of the coated areas.

In another advantageous embodiment, two mutually opposite, parallel narrow faces are intended for light coupling, and the interfering capability of the coated areas increases progressively with growing distances x1, x2 in strip-shaped segments aligned in parallel with the narrow surfaces, up to a common maximum.

In another embodiment, by contrast, the interfering capability of the particles is essentially homogeneous, both in each of the areas and across the extension of the emission plane. Light coupling is preferably through two mutually opposite, vertical narrow surfaces. In selected areas of the wavelength filter array that comprise one or several rows and/or columns each, do not overlap each other, and, in their entirety, completely cover the wavelength filter array, the ratio between the surface areas covered by filter elements transparent to light of specified wavelength ranges and the surface areas covered by opaque filter elements is defined depending on the luminance maximally achievable in those area segments of the emission plane of the planar light source that, in case of projection along a direction normal to the area, each correspond to an area thus selected of the wavelength filter array.

In this connection, the filter structure is, so to speak, adapted to the conditions prevailing in the optical waveguide (row by row or/and column by column): With the particles used for outcoupling having a constant interfering capability, it is normally possible, thanks to the second light source, to achieve a relatively high luminance at the margin, i.e. close to the narrow surfaces used for light coupling, while the luminance decreases towards the center. To compensate this drop in luminance, the ratio between the surface areas covered by filter elements transparent to light of specified and the surface areas covered by opaque filter elements is made smaller at the margin, i.e. near the narrow coupling faces, than in the center of the second light source. In that way, the outcoupling of light due to the particles is greater in the center of the light guide than at the margin, a difference that is essential to the function of the arrangement. In toto, this measure just compensates the property of the light guide to emit more light close to the coupling surfaces. As a result, the second light source is essentially homogeneous.

The said ratio between filter elements that are opaque and those that are transparent to light of specified wavelength ranges may, at the margin, i.e. close to the narrow coupling surfaces, be 7:1, for example. If the luminance achievable in the center (i.e. between the two narrow light coupling surfaces) of the second (the planar) light source is somewhat lower than at the margin, it is possible there to select, for example, a ratio between opaque filter elements and those transparent to specified wavelength ranges that is approximately 10:1, so that more light is coupled out there due to the greater particle areas or the greater number of particles arranged on the areas provided with opaque filter elements. Altogether, in this way, an approximately homogeneous luminance distribution is achieved on account of the second light source. As a matter of course, the surface area ratios of 7:1 or 10:1 mentioned above are not the only ones intended and may be, for example, 8:1, 9:1, or even be one of non-integral numbers.

It should be noted that, due to the influence thus exerted on the wavelength filter array, the 3D impression perceived is influenced as well; this is especially explained by the fact that the selection of views seen monocularly, and specially the relative share of image information from different views is immediately influenced by the said ratio described above.

Further, the coating that interferes with total reflection there may be provided with a top coat that essentially absorbs light.

As a further advantage, the arrangements according to the invention described so far are also characterized in that the means for illumination is provided with a control system for the first light source, which generates a luminance gradient with reference to the plane of the wavelength filter array. This allows a compensation of inhomogeneities of the brightness of the second light source, and thus of inadequacies in the homogeneity of the perceived brightness of the 2D image in the second mode of operation. Also, the luminance gradient in the first light source can be used for homogenizing the luminance in the 3D mode, i.e. in the first mode of operation.

Instead of switching on the first light source in addition, the second light source alone can be used to deliver a homogeneous illumination if a weak diffusion disk is inserted behind the image display device.

As an example, the means of illumination may include a first light source in the form of a discharge lamp having a plane exit window that faces the wavelength filter array and is parallel to it. Depending on whether or not the first light source is a discharge lamp, the said luminance gradient can also be achieved by switching and a suitable control system. The inside of the exit window is coated with a luminescent material.

Preferably the luminescent coating is applied only in those areas that, in case of projection onto the wavelength filter array along a direction normal to the plane, are essentially congruent with the areas covered by filter elements that are transparent to the specified wavelength ranges. This ensures that essentially none of the light emitted by the luminescent coat is absorbed or obstructed by filter elements opaque to light, but rather illuminates the rear side of the image display device.

In this arrangement it is favorable if the wavelength filter array is provided on the outside of the exit window.

Further, in the second mode of operation, a share of the light of the first light source may, by means of optical elements, be coupled out and coupled into the second light source, the share being defined by the ratio between surface areas covered by filter elements transparent to specified wavelength ranges and surface areas covered by opaque filter elements in the wavelength filter array. Particularly suitable means for outcoupling and coupling, in this connection, are optical light guides and/or reflecting elements.

Moreover, some optically effective material, preferably a filter plate or a thin foil with a microstructure of prismatic effect, may be arranged between the first and second light sources, which essentially prevents light of the first light source having an angle of incidence greater than the critical angle of the second light source from entering the second light source. In addition, a filter plate with a filter array of several millimeters thickness can be used for vignetting the light rays. The thickness of the filter layer is approximately in the order of magnitude of the transparent filter elements and may, for example, be between 0.1 mm and 0.3 mm.

In yet another embodiment of the arrangement according to the invention, the second light source comprises a multitude of individually controllable light sources which emit light in the direction of the image display device and are, at the same time, configured as opaque filter elements in the wavelength filter array. The light sources in this connection may be, for example, light-emitting, essentially plane polymer layers.

The problem is also solved according to the invention by an arrangement for displaying the images of a scene or object by means of an image display device consisting of a multitude of translucent image rendering elements on which bits of image information from several perspective views of the scene or object can be displayed, and of an array, arranged (in viewing direction) behind the image display device, which contains a multitude of light sources that are arranged in rows and/or columns, can be controlled individually and emit light in specified wavelength ranges, this arrangement having a first mode of operation in which light is emitted only by those light sources the light of which reaches the observer through portions of the image rendering elements of the image display device that are assigned to each respective light source, resulting in a three-dimensional image display, and a second mode of operation in which light is additionally emitted by at least another portion of the light sources the light of which reach the observer through image rendering elements of the image display device without any particular assignment, resulting in an image display that is at least partially two-dimensional.

The light sources in this arrangement may be essentially plane, light-emitting polymer layers. Alternatively, it is also possible to use a liquid crystal display for illumination. The problem is also solved according to the invention by an arrangement as described by the generic part of claim 2, in which, as a means for uniform illumination in the second mode of operation, a light outcoupling structure that can be switched on and off is provided on at least one of the large surfaces.

Preferably, the said light outcoupling structure that can be switched on and off is a switchable scattering layer located at a slight distance from, or preferably in contact with, the wavelength filter array.

The switchable scattering layer is switched to be transparent in the first mode of operation and to be scattering in the second mode of operation. Preferably, the switchable scattering layer is, in the second mode of operation, switched to be scattering throughout the layer area. This corresponds to the case that an image perceived as two-dimensional is displayed on the entire display area of the image display device.

In further embodiments of the invention, only partial areas of the switchable scattering layer are switched to be scattering in the second mode of operation. Preferably, these partial areas are configured as narrow stripes, which may have different widths. Any two nearest-neighbor stripes may be separated by permanently transparent stripe-shaped partial areas on the switchable scattering layer, so that the degree of light outcoupling from the light guide per (sufficiently large) unit of area varies with the location on the light guide. Permanently transparent stripe-shaped partial areas may be, in particular, regions of a switchable scattering layer that are permanently switched to be transparent, or blank regions of the light guide that are not provided with a switchable scattering material.

Thus, the local degree of light outcoupling is determined by the local variation of the width and special frequency of the stripe-shaped partial areas of the switchable scattering layer (“geometric adaptation of the degree of light outcoupling” with the aim of homogenizing the luminance). In this way it is possible, in toto, to improve the homogeneity of illumination of the image display device by means of the second light source—for example, if the degree of light outcoupling close to the laterally arranged, inward-coupling light sources is lower than at a certain distance from them.

In addition it is possible that the switchable scattering layer in the second mode of operation is switched to have differing degrees of scattering power in different places, so that the degree of light outcoupling from different placed of the light guide varies likewise. To obtain locations of differing scattering power on the switchable scattering layer, pairs of different control signals are applied to it.

This last-named capability, an “electrical adaptation of the degree of light outcoupling”, may further be combined with the previously described geometric adaptation in order to achieve a particularly homogeneous 2D illumination.

Further, it is of advantage if the opaque filter elements of the wavelength filter array on the side facing the observer are diffusely scattering, for example, by means of a coat of matte white paint. This will diffusely backscatter any light coupled out on the side facing the filter array, resulting in a brighter, more efficient illumination in the second mode of operation. Alternatively, the opaque filter elements may be provided with a reflecting layer.

Moreover, the large surfaces of the light guide in the second light source preferably have plane and/or structured shares. The structured shares can have an added influence on the local degrees of light outcoupling.

The switchable scattering layer may, for example, be a liquid crystal layer—especially one having a cholesteric-nematic transition—, which is transparent if a suitable electric potential is applied, and scattering if this potential is missing. Preferably, the switchable scattering layer is switchable scattering disk of the type “Polymer Dispersed Liquid Crystal (PDLC) Film” made by Sniaricerche (Italy).

It is also possible, for the further improvement of homogeneity and increase in brightness, to switch on the first light source in addition to the second light source in the second mode of operation. If the brightness on the areas of the opaque filter elements (corresponding to the light of the second light source) is equal to that on the areas of the transparent filter elements (corresponding to the light of the first light source), there results a (macroscopically) homogeneous 2D illumination for the second mode of operation.

The last-named embodiment has many advantages. In particular, it is easy to fabricate the light guide for the second light source, as no expensive masters for injection molds for microstructuring the surface of the light guide are required. If liquid crystals are used in the switchable scattering layer, a microscopic light outcoupling structure is produced inherently, which in the 2D mode (second mode of operation) cannot be resolved by the unaided eye. The versions described above for geometric and/or electric homogenization of illumination in the second mode of operation permit the second light source to be optimized for displays of different types and sizes. One substantial advantage of the invention is that there are, in the first mode of operation, no visually disturbing or visible light outcoupling patterns light guide, nor any moiré effects. Compared to the prior art, the light guide need not be arranged in close contact with the filter array, which has advantages for manufacturing.

The problem is also solved according to the invention by an arrangement as described by the generic part of claim 2, in which, as a means for uniform illumination in the second mode of operation, a switchable scattering disk is arranged between the light guide and the image display device, which is switched to be transparent in the first mode of operation and to be scattering in at least part of its surface area in the second mode of operation, so as to reduce the brightness contrast of the light passing the switchable scattering disk in the second mode of operation. The contrast reduction contributes to homogenizing the illumination in the second mode of operation, i.e., in the mode for two-dimensional display.

In the last-named embodiment of the invention, too, the first light source may be switched on in addition to the second one in the second mode of operation. Unlike the embodiment described first, however, the brightness of the first light source (which emits light towards the observer through the transparent filter elements and further components of the arrangement) may be much higher than the brightness of the second light source (the light of which is emitted towards the observer especially on the opaque filter elements). As a result, a yet higher brightness is achieved in the second mode of operation.

The embodiment of the invention described last has the added advantage of particularly high image brightness in the second mode of operation, as it provides a feedback of light into the light guide. If the second and first light sources are switched on in the second mode of operation, any brightness contrasts occurring will be compensated by means of the scattering disk that is switched to be scattering. In this embodiment, in particular, it is of advantage that the light guide need not have a microscopic structure, as the scattering disk makes its structure invisible in the second mode of operation. Altogether, the illuminating light for the second mode of operation is highly homogeneous and of good brightness.

Further, the problem is also solved according to the invention by an arrangement as described in claim 38.

As it uses two wavelength filter arrays that can be displaced relative to each other, this embodiment also permits the image brightness in the first and/or second mode of operation to be varied, say, if the filter arrays occupy different positions relative to each other. Variation in the first mode of operation further makes it possible to adapt the resulting “summary” filter array to match varied numbers of views to be displayed.

Preferably, two filter arrays of the same kind are used, which are arranged without any optical distance between them in order to avoid moiré effects. By the way, the filter arrays may also be configured without any opaque filter elements.

Just as well there may be more than two wavelength filter arrays of a (total) number W, of which at least W-1 wavelength filter arrays can be displaced.

Preferably, each shiftable wavelength filter array is shiftable along the rows of the raster of image rendering elements of the image display device. With particular preference, the displacement travel of each shiftable wavelength filter array is smaller than the horizontal period of the transparent filter elements provided on the respective wavelength filter array, if such a period exists.

As a rule, the displacement of each shiftable wavelength filter array is effected by an electromechanical control element, for example, a piezoelectric positioner.

The problem is also solved according to the invention by an arrangement as described by the generic part of claim 2, in which, as a means for uniform illumination in the second mode of operation, an optically scattering foil is provided between the wavelength filter array and the light guide, which preferably is designed to diffusely reflect, or re-emit, white light.

In its simplest form, such a foil is structureless and has homogeneous optical properties in that it diffusely scatters incident light. Therefore it may not only be very thin but also have a high flexibility, and it can be made at low cost. In a preferred embodiment of the invention, therefore, the intention is to switch to the first mode of operation by removing the foil from between the wavelength filter array and the light guide. This can be done manually, but preferably by means of a winding and unwinding mechanism.

Therefore, the brightness achievable in the second mode of operation is just as high as the brightness of conventional 2D monitors, so that additional illumination by means of the first light source can be dispensed with and thus energy be saved. The illumination in the second mode of operation is homogeneous, there are no moiré fringes.

Nevertheless it is possible, though, to switch on the first light source in addition, if the foil, for example, has a transmittance different from zero, so that image brightness can be increased in this way.

In another embodiment of the invention, the foil is designed as an electrophoretic component. It is transparent to light in the first mode of operation, and optically diffusely scattering in the second mode of operation. Switching between the first and second modes is by influencing the electrophoretic properties. The essential advantage of this embodiment is that there is no need to remove or insert the foil mechanically.

The wavelength filter array can also be designed as an electrophoretic component. In this case it is provided with a control system for controlling the opaque filter elements. These are switched to absorb light in the first mode of operation, and diffusely reflect, or back-scatter, light in the second mode of operation.

Finally, the problem is solved by an arrangement for displaying the images of a scene or object consisting of an image display device incorporating a multitude of image rendering elements that are transparent to light and arranged in a raster of rows and/or columns, on which bits of image information from several perspective views of the scene or object can be displayed, and further consisting of a plane, controllable wavelength filter array that is arranged (in viewing direction) behind the image display device, and incorporates a multitude of filter elements arranged in rows and/or columns, some of which are transparent to light of specified wavelength ranges, and further consisting of a light source that is arranged (in viewing direction) behind the wavelength filter array and is preferably a planar light source, wherein, in a first mode of operation, the remaining part of the filter elements is controlled to be opaque to light, light from the light source reaches the observer through at least part of the transparent filter elements and subsequently through an assigned part of the image rendering elements of the image display device, so that the scene or object can be seen by the observer in three dimensions, and wherein the wavelength filter array is designed as an electrophoretic component, and wherein, in a second mode of operation, the remaining part of the filter elements is controlled to be transparent to light, so that the scene or object can be seen by the observer in two dimensions.

In this arrangement the additional second light source in the second mode of operation can be dispensed with, so that components such as the light guide and the means of its illumination are not required. This also improves the quality of display in the first mode of operation.

It may further be of advantage if, in the first mode of operation of each of the embodiments of the invention described so far, i.e. in the mode providing at least a partially three-dimensional display, either eye of the observer predominantly but not exclusively sees a certain selection of the displayed bits of image information from several perspective views of the scene or object, so that the observer has a spatial impression. Examples of how a spatial impression is produced under these conditions are described, e.g., in DE 20121318 U and WO 01/56265 of the present applicant.

Each of the embodiments described may be designed in such a way that a three-dimensional image is displayed only on part of the image display device, whereas a different, two-dimensional image is displayed on the remaining part, or vice versa, i.e. that different partial areas of the image display device are controlled in different modes of operation.

As a matter of course, the respective second mode of operation should only display a two-dimensional image rather than an image composed from several views, which can easily be achieved by suitable controlling of the image display device.

### BRIEF DESCRIPTION OF THE DRAWINGS

Below, the invention is described in detail. Reference is made to the accompanying drawings, most of which are not to scale, and in which:

FIG. 1 shows the general principle of a first embodiment of arrangements according to the invention,

FIG. 2 shows an example of a wavelength filter array for use in the first embodiment of arrangements according to the invention (detail),

FIG. 3 shows an image combination rule for displaying image information from several (here: nine) views on the image display device (detail),

FIG. 4 shows an example of a monocular vision, based on the conditions prevailing in FIG. 2 and FIG. 3,

FIG. 5 shows another example of a wavelength filter array for use in the first embodiment of arrangements according to the invention (detail),

FIG. 6 shows another image combination rule for displaying image information from several (here: eight) views on the image display device (detail),

FIG. 7 shows an example of a monocular vision, based on the conditions prevailing in FIG. 5 and FIG. 6,

FIG. 8 is a schematic presentation of the joint action of the first and second light sources for the purpose of homogeneously illuminating the image display device,

FIG. 9 shows another example of a wavelength filter array for use in the first embodiment of arrangements according to the invention (detail),

FIG. 10 shows another image combination rule for displaying image information from several (here: eleven) views on the image display device (detail),

FIG. 11 shows an example of a monocular vision, based on the conditions prevailing in FIG. 9 and FIG. 10,

FIG. 12 shows another example of a wavelength filter array for use in the first embodiment of arrangements according to the invention (detail),

FIG. 13 shows another image combination rule for displaying image information from several (here: 9) views on the image display device (detail),

FIG. 14 shows an example of a monocular vision, based on the conditions prevailing in FIG. 12 and FIG. 13,

FIG. 15 shows a special form of the first embodiment of the arrangement according to the invention, in which light of the first light source having angles of incidence greater than the critical angle of the second light source is essentially prevented from entering the second light source,

FIG. 16 shows another example of a wavelength filter array for use in the first embodiment of the arrangements according to the invention (detail),

FIG. 17 shows yet another example of a wavelength filter array for use in the first embodiment of the arrangements according to the invention (detail),

FIG. 18a shows the principle of a second embodiment of arrangements according to the invention,

FIG. 18b shows the principle of the possible design of a light outcoupling structure that can be switched on and off,

FIG. 18c shows the principle of another possible design of a light outcoupling structure that can be switched on and off,

FIG. 19 shows the principle of the first mode of operation of the second embodiment of arrangements according to the invention,

FIG. 20 shows the principle of the second mode of operation of the second embodiment of arrangements according to the invention,

FIG. 20a shows another principle of the second mode of operation of the second embodiment of arrangements according to the invention,

FIG. 21 shows the principle of a special embodiment of the light outcoupling structure that can be switched on and off, which embodiment ensures that the degree of light outcoupling from the light guide per unit area differs for varied locations on the light guide,

FIG. 22 shows the principle of another special embodiment of the light outcoupling structure that can be switched on and off, which embodiment ensures that the degree of light outcoupling from the light guide per unit area differs for varied locations on the light guide,

FIG. 23 shows the principle of a third embodiment of arrangements according to the invention,

FIG. 24 shows the principle of a fourth embodiment of arrangements according to the invention, shown in the first mode of operation,

FIG. 25 shows the principle of a fourth embodiment of arrangements according to the invention, shown in the second mode of operation,

FIG. 26 shows an example of a filter array for use in the third embodiment of arrangements according to the invention,

FIG. 27 shows a position of two filter arrays relative to each other, for use in the first mode of operation of the third embodiment of arrangements according to the invention,

FIG. 28 shows a special embodiment of a wavelength filter array,

FIG. 29 shows another special embodiment of a wavelength filter array,

FIG. 30 shows an electrophoretic wavelength filter array,

FIG. 31 shows an electrophoretic wavelength filter array that can be switched off,

FIG. 32 shows an electrophoretic, optically scattering foil, and

FIG. 33 shows an optically scattering foil that can be wound and unwound mechanically.

### DESCRIPTION OF THE DRAWINGS

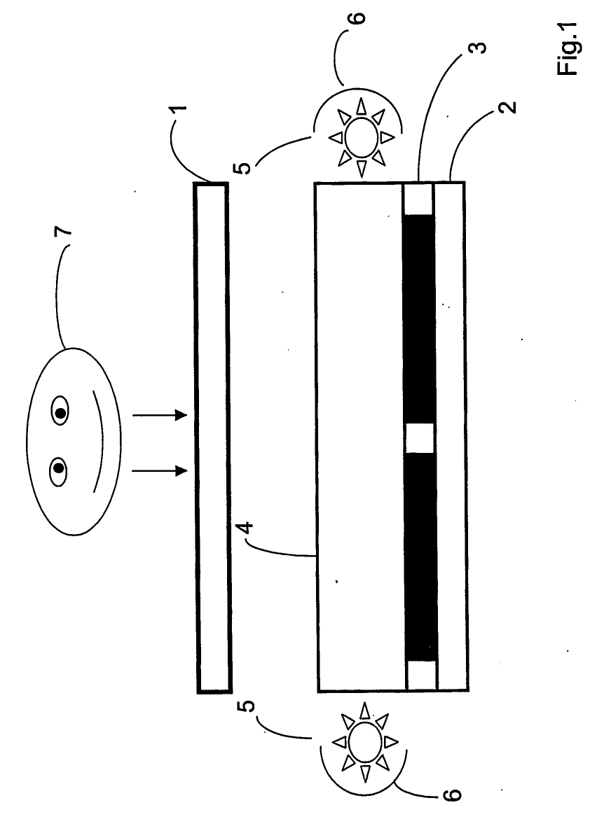

FIG. 1 shows the general principle of a first embodiment of an arrangement according to the invention, having an image display device 1 consisting of a multitude of image rendering elements, which is followed, in the viewing direction of an observer 7, by a wavelength filter array 3 with filter elements, part of which are transparent and part of which are opaque to light. In a first mode of operation, light from a first light source 2 arranged behind the wavelength filter array 3 reaches the observer 7 by passing through at least part of the transparent filter elements of the wavelength filter array 3 and subsequently through a correlated part of the image rendering elements of the image display device 1, so that the scene or object is visible to the observer 7 in three dimensions. In a second mode of operation, additionally light of a second light source 4, which has an emission plane arranged between the wavelength filter array 3 and the image display device 1 and essentially parallel to the wavelength filter array 3, reaches the observer 7 by leaving the said emission plane and passing through the image rendering elements of the image display device 1 but not through the filter elements of the wavelength filter array 3, so that the scene or object is visible to the observer 7 at least partially in two dimensions. In this arrangement, only those areas of the emission plane of the second light source 4 are intended for light emission that, in case of projection onto wavelength filter array 3 along a direction normal to the plane, are essentially congruent with the areas covered by opaque filter elements.

The wavelength filter array 3 may have a thickness of, e.g., several tens of μm up to a few millimeters; it is shown thicker in FIG. 1 for clarity only.

So, for the purpose of 2D imaging, an additional (second) light source 4 is switched on, which emits light essentially from areas that correspond to those areas on the wavelength filter array 3 which are covered by opaque filter elements.

Advantageously, the second light source 4 in this arrangement is a planar light source in the form of an optical waveguide slab (light guide), which has two large surfaces lying opposite to each other and narrow surfaces around its periphery, in which the large surface facing away from the image display device 1 corresponds to the emission plane, and in which one or several light sources arranged laterally and possibly provided with reflectors 6 feed light into the light guide. This light is coupled into the light guide via one or several of the narrow peripheral surfaces, partially reflected back and forth between the large surfaces of the slab due to total reflection, and partially outcoupled at the large surface that corresponds to the emission plane.

Here, the wavelength filter array 3 is provided on that large surface of the light guide which corresponds to the emission plane.

Further, those areas of the large surface corresponding to the emission plane that are intended for emission are provided with a particle coating that interferes with total reflection. The interfering capability of the particles is essentially homogeneous, both in each of the areas and throughout the extension of the emission plane. As mentioned before, the particles are provided preferably on the opaque areas of the filter array and on the said large surface.

The emission plane is considered to be that large surface of the light guide that is directly in contact with the interfering particles, because it is here that interference with the light propagation directions in the light guide takes place for the purpose of final light outcoupling (on the other large surface of the light guide).

Two parallel, mutually opposite narrow surfaces of the light guide are intended for inward light coupling, as indicated by the two light sources 5 in FIG. 1.

The wavelength filter array 3 may have, for example, one of the structures as described in DE 2012131 8.4 U. Furthermore, preferably the image combinations described therein for the respective filter arrays will be used.

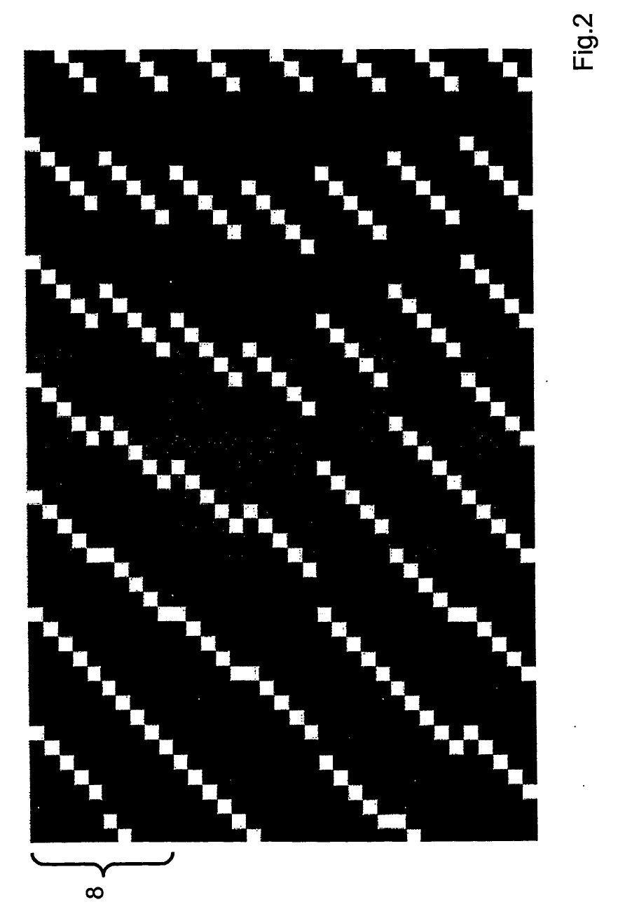

With reference to FIGS. 2, 3 and 4, a particularly advantageous embodiment of the invention is now described: In selected, non-overlapping areas of the wavelength filter array 3 that each comprise one or several rows and in their totality completely cover the wavelength filter array 3, the ratio of surface areas covered by filter elements that are transparent to light of specified wavelength ranges to surface areas covered by opaque filter elements is specified as a function of the maximally achievable luminance in those partial areas of the emission plane of the that in case of projection along the direction normal to the surface correspond to a partial area so selected of the wavelength filter array. For easier comprehension, it is noted here that—as indicated above—the interfering particles, which participate in light outcoupling, are provided immediately on the opaque filter elements. Therefore, the partial areas shown black in FIG. 2 do not necessarily appear really black to the human eye when illuminated, but have the color of the interfering particles, which is preferably white.

For example, with reference to FIG. 2, a ratio of 7 opaque filter elements to 1 filter element transparent in a specified wavelength range (here: the visible range) is implemented in the first five rows of the filter array 3, which is not shown true to scale here but greatly enlarged. Assuming that the narrow sides of the light guide used for inward light coupling are horizontal and (in the plane of the drawing) situated above and below the filter area, most of the light is first coupled out at the upper and lower edges of the light guide, and it is there that a relatively high luminance of the light outcoupled from the light guide can be achieved, compared, e.g., to the center of the filter area and, thus, of the light guide.

In order to compensate this drop in luminance from the margin toward the center, the ratio of surface areas covered by filter elements transparent to light of specified wavelength ranges to those covered by opaque filter elements is selected to be smaller on the margin close to the narrow light coupling surfaces than, say, the center of the second light source 4, as shown in FIG. 2. In that way, more light is coupled out in the center of the light guide because of the greater areas provided with interfering particles, than on the margin—a fact that is essential to the function of the arrangement. This very fact compensates, in the aggregate, the property of the light guide to radiate a particularly great amount of light close to the inward coupling surfaces. As a result, the second light source acts as a homogeneous light source.

In the example illustrated in FIG. 2, the said ratio between opaque filter elements and those transparent to specified wavelength ranges is 10 to 1 in the center of the light guide and, thus, of the filter array 3, so that more light is outcoupled there because of the larger particle-occupied areas or the greater number of particles (the particles being provided on the partial areas covered with opaque filter elements); as a result, the overall distribution of luminance due to the second light source is approximately homogeneous. As a matter of course, besides the ratios of 7 to 1 or 10 to 1 between the partial areas there may be other ratios, such as 8 to 1 or 9 to 1.

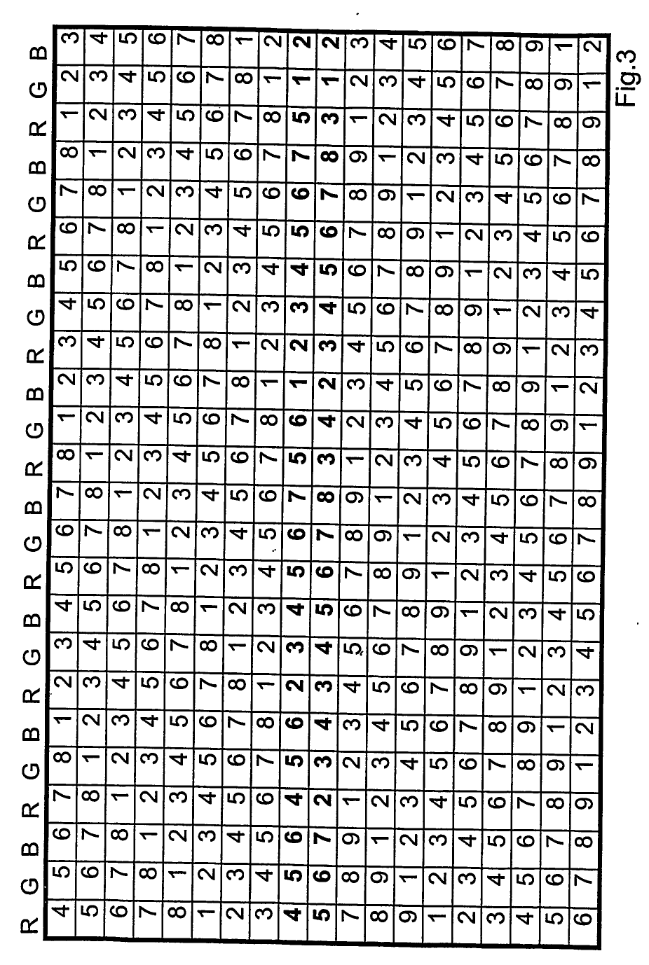

FIG. 3 shows an example of an image combination for displaying image information from several views. This takes into account that, due to the structure of the wavelength filter array, the arrangement of the bits of image information needs to be changed. Each square represents one pixel of the image display device 1; the columns R, G, B exemplify the red, green and blue subpixels of an image display device 1 configured as an LCD. The numbers in the squares denote the view from which the image information in the respective position originates. The drawing is not to scale but greatly enlarged.

Whereas 8 views are used in the upper rows of FIG. 3, 9 views are used in the rows further down. The two rows in bold print are transition rows that, in a way, ensure a transition from 8 views to 9 views.

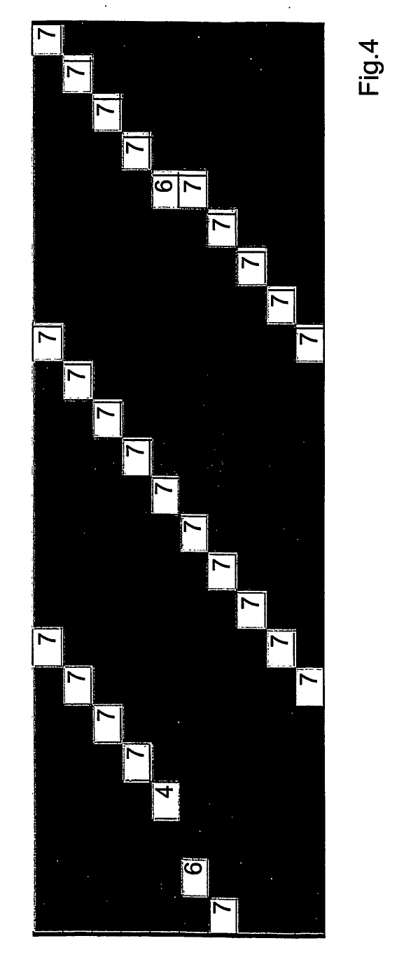

FIG. 4 shows an example of a monocular vision from a viewing position, making allowance for the situation described for FIG. 2 and FIG. 3. This example shows a segment only of the wavelength filter array 3, i.e. the rows marked 8 in FIG. 2.

It is thus easy to understand that, because of the design of the wavelength filter array 3 as described above, the observer's 3D impression is also influenced; this is especially due to the fact that selection of views visible monocularly, and, in particular, the relative share of image information from different views is immediately influenced by the said ratio of the partial areas on the wavelength filter array 3.

Furthermore, to achieve an excellent opacity of the opaque filter elements, another, essentially light-absorbing layer is provided on top of the layer that interferes with total reflection.

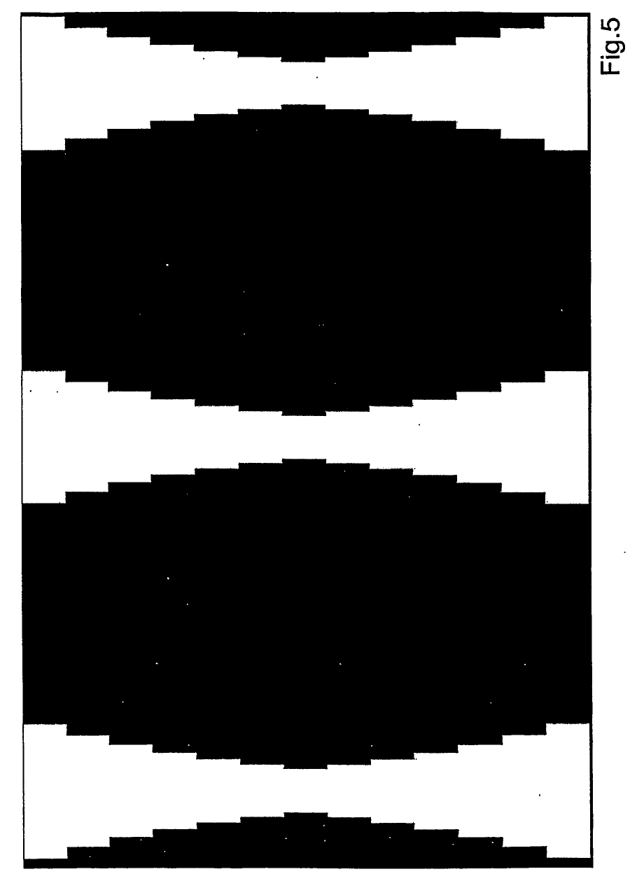

To illustrate another example of an embodiment making use of the variation of the ratio of partial areas with opaque filter elements to partial areas with filter elements transparent to light of specified wavelength ranges, reference is made below to FIGS. 5 through 8.

FIG. 5 shows, not to scale and greatly enlarged again, another wavelength filter array structure, for which the ratio between opaque and light-transparent elements—and thus the share of interfering particles used for light outcoupling from the light guide—increase is from the upper and lower margin towards the center. This has the advantageous effect described above that, due to the increased outcoupling rate in the center of the light guide, an essentially homogeneous light emission from the slab is achieved. As for FIG. 2, the argument applies that the filter elements shown black have, in principle, the color of the interfering particles of the side facing the light guide, preferably white. However, if they do not receive light from the second light source—here, the light guide—, they appear black, indeed, or without emitting any light, as shown in FIG. 5. This is important for the first mode of operation, i.e. the 3D mode.

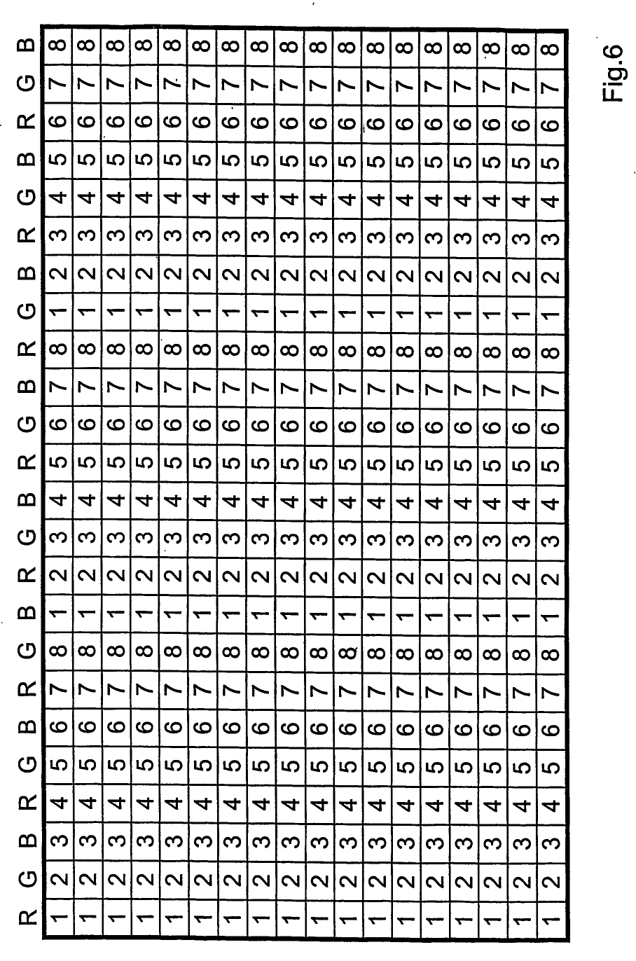

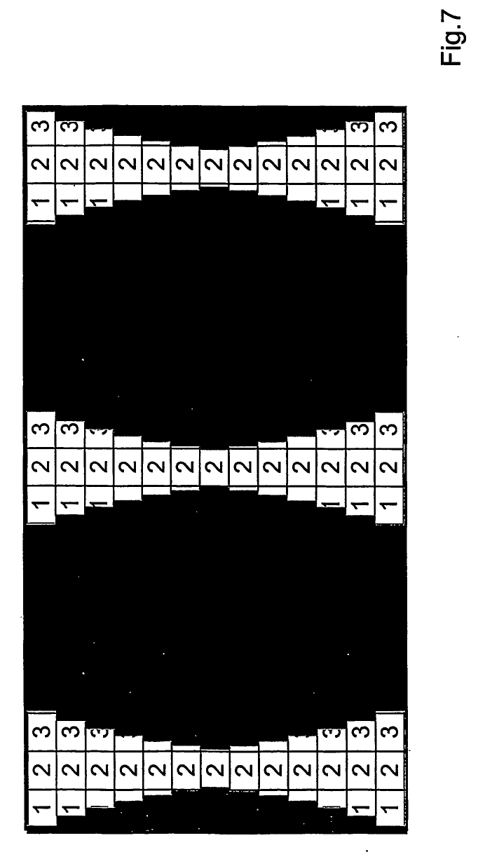

FIG. 6 shows an example of an image combination suitable for the filter array illustrated in FIG. 5, which creates a spatial impression in the 3D mode (first mode of operation). Here again, the columns R, G, B represent the color subpixel columns of the colors red, green and blue. Accordingly, the monocular vision shown as an example in FIG. 7 is possible. The observer's eye in the respective position mainly sees view 2, but also minor shares of views 1 and 3. If the observer's other eye saw, for example, a mix (not shown in the drawing) of, say view 5 and minor shares of views 4 and 6, the observer would see a spatial image. This makes it evident again that the ratio between opaque and light-transparent filter elements that influences the structure of the filter arrays 3 (and, thus, the ratio between areas provided with interfering particles and areas without such particles) has a direct, inseparable influence on the image perceived.

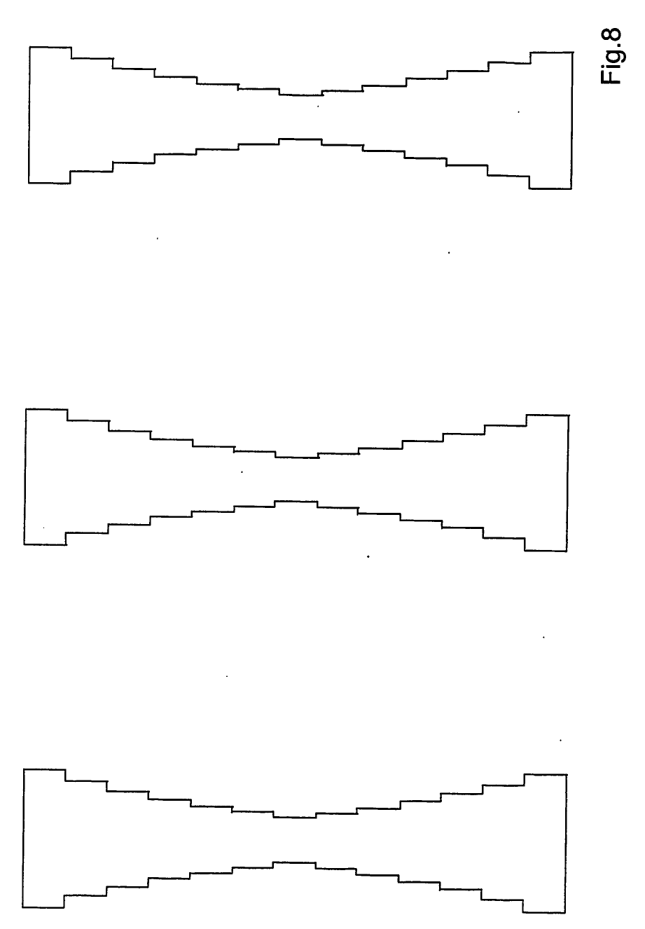

In order to change over, for example, to the second mode of operation, i.e. the 2D mode, the second light source 4 is switched on in addition to the first light source 2. In the example shown here, the lamps 5 are switched on and their light is coupled into the light guide. Because of the light outcoupling from the light guide, which is influenced as described above, the light emitted by the light guide is essentially homogeneous. The partial areas of the large surface of the second planar light source 4 (i.e., of the light guide) that are not provided with interfering particles correspond to the partial areas covered with filter elements transparent to light of specified wavelength ranges. Here, for example, these are filter elements that are transparent to the complete visible spectrum, which are shown white in FIG. 5. In the second mode of operation, these filter elements still transmit light of the first light source 2, so that the light of the first light source 2 and that of the second light source 4 supplement each other essentially homogeneously in this second mode of operation. What is achieved here, virtually, is a very low contrast of the cumulative illumination supplied for the image display device 1 by the first and second light sources 2, 4. The said contrast approximates zero. This is indicated in FIG. 8 in that the boundaries of the light supplied by the two light sources 2, 4 are drawn on the area observed. That the areas are shown white is to illustrate the light emission.

Accordingly, FIG. 8 schematically illustrates the interaction of the first and second light sources 2, 4 for the purpose of homogeneous illumination of the image display device 1. In other words, the first light source 2, interacting with the wavelength filter array 3, corresponds to 3D illumination of the image display device 1, whereas the second light source 4 practically has the function of a 2D supplementary illumination, as it is switched on for the 2D mode in addition to the 3D mode illumination, i.e. the first light source 2.

It goes without saying that the image content displayed by the image display device 1 should be two-dimensional for the second mode of operation. This 2D image content is then perceived in two dimensions as usual.

Advantageously, the means of illumination is provided with a control device for the first light source 2 for producing a luminance gradient with reference to the plane of the wavelength filter array 3. This allows any inhomogeneity still present in the brightness of the second light source 4 to be compensated, so that inadequacies with regard to the homogeneity of the perceived brightness of the 2D image in the second mode of operation are evened out. Also, the said luminance gradient of the first light source 2 can be used for the homogenization of luminance in the 3D mode, i.e., the first mode of operation.

In this example, the means of illumination comprise, as the first light source 2, a discharge lamp with a plane sealing glass facing, and parallel to, the wavelength filter array 3. Depending on whether or not the first light source 2 comprises a discharge lamp, it is thus possible to switch on the said luminance gradient by means of a suitable control device. The inside of the sealing glass is provided with a phosphor coating.

Advantageously, the phosphor coating is applied only in such areas that, in case of projection along a direction normal to the plane of the wavelength filter array 3, are essentially congruent with the areas covered by filter elements transparent to light of specified wavelength ranges. This ensures that all the light emitted by the phosphor illuminates the rear side of the image display device 1 rather than being essentially absorbed by opaque filter elements. It is of advantage, for this purpose, if the wavelength filter array 3 is provided on the outside of the sealing glass.

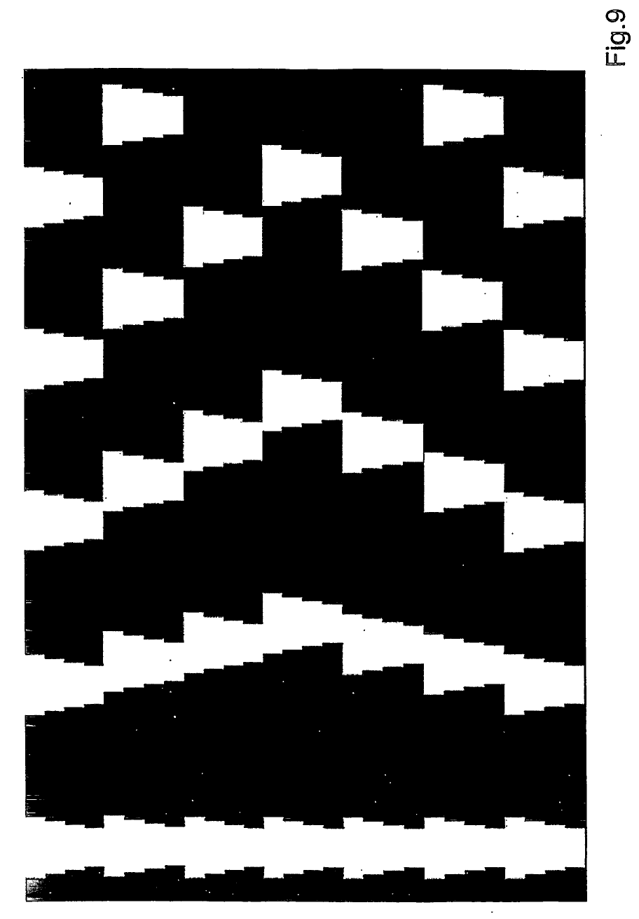

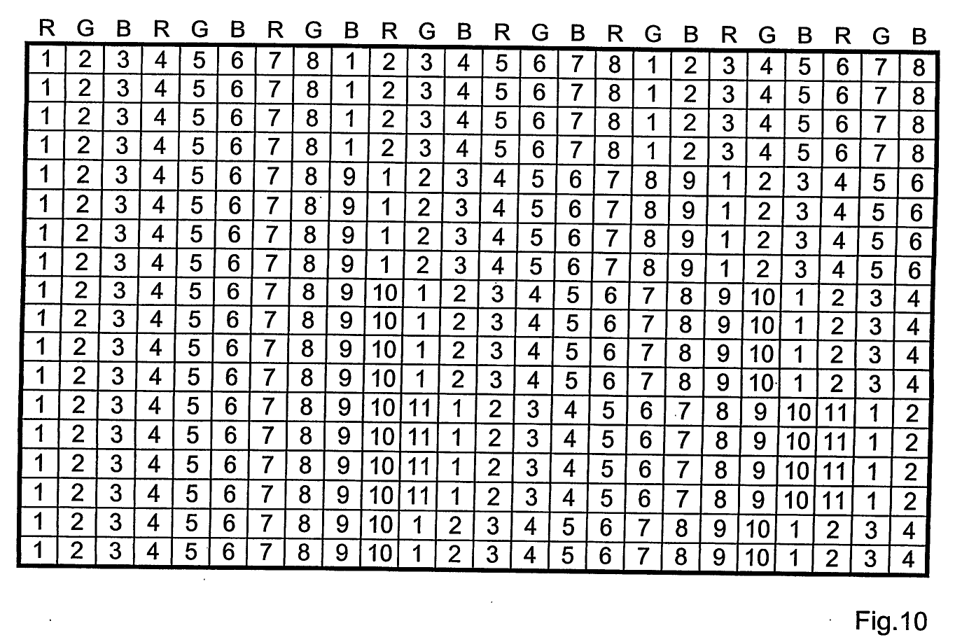

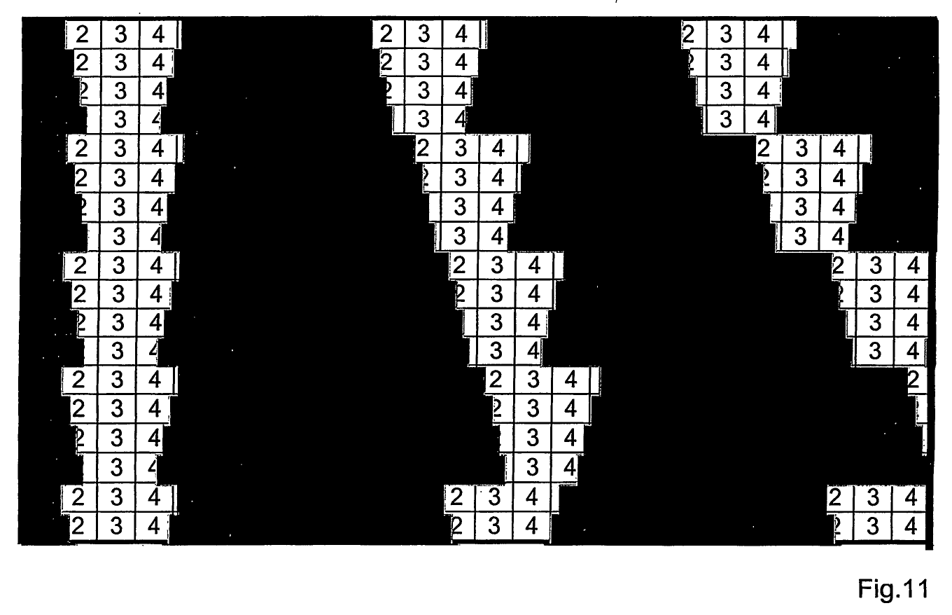

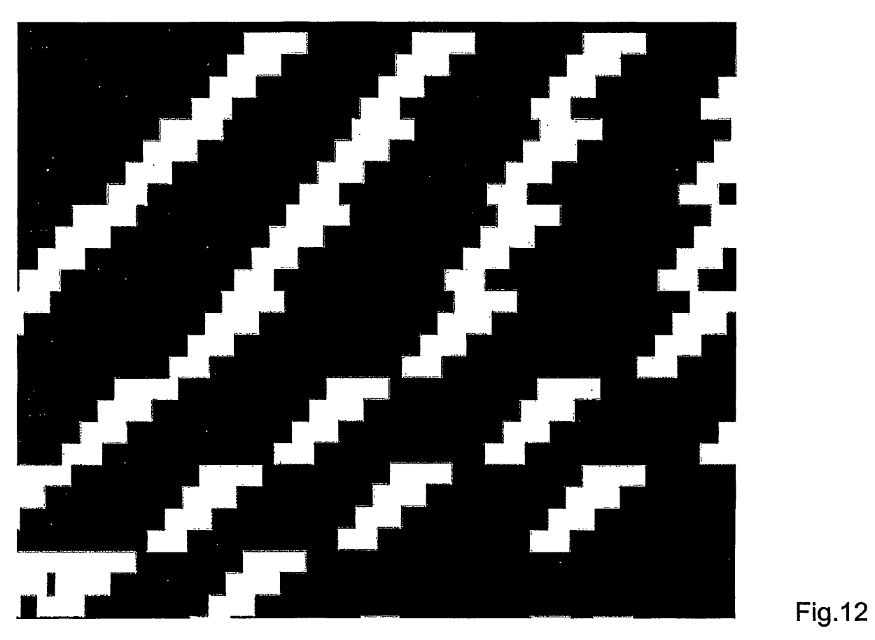

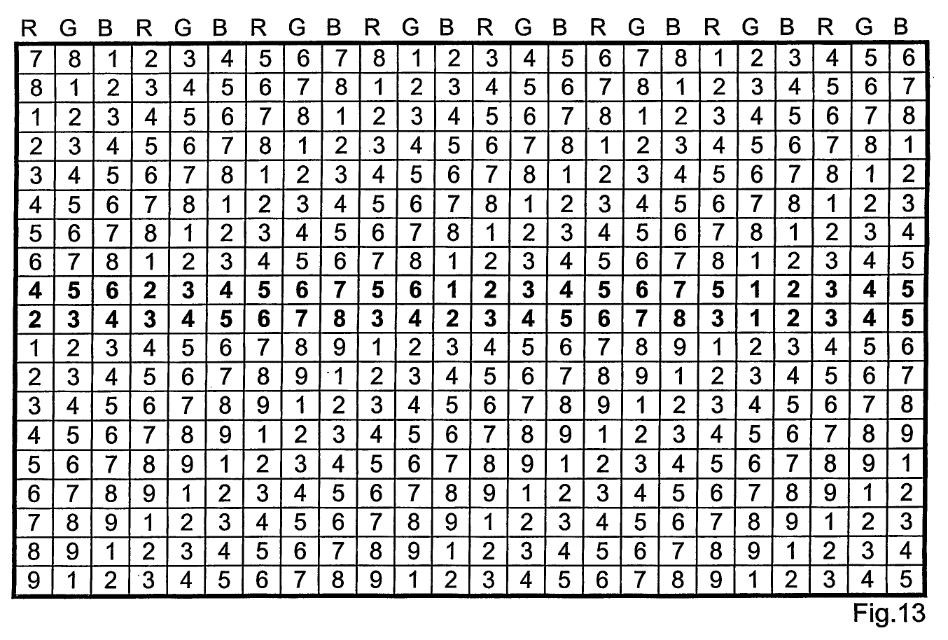

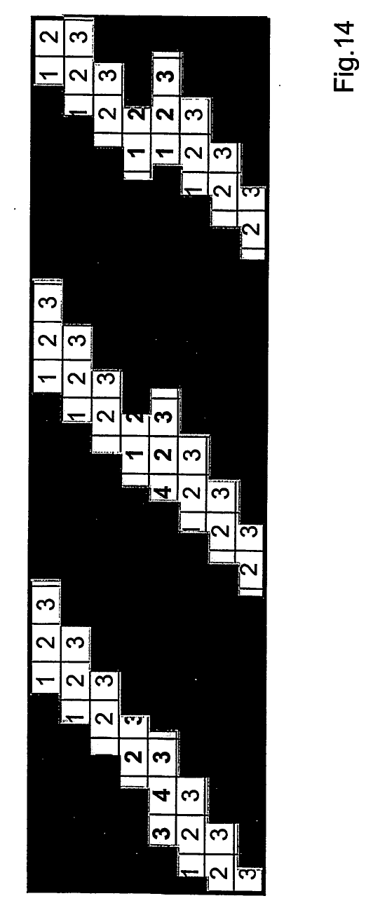

Further examples of embodiments are illustrated by FIGS. 9 through 11 and by FIGS. 12 through 14, with the descriptions for FIGS. 5 through 7 being applicable analogously, so that a repeated description can be omitted here. As a particularity of these embodiments of the filter array it should be noted, though, that the width or (in case of equal size) the number of filter elements that are transparent to light of specified wavelength ranges varies from row to row. This influences both the 3D impression and the amount of light outcoupling, due to the changed structure of the wavelength filter array 3 and, thus, the arrangement of the interfering particles. Embodiments of this kind permit, in particular, the distance between the filter array 3 and the image display device 1 to be increased, which eliminates the need to use thin light guides.

Outlined below is a general method for increasing the distance between the filter array 3 and the means of illumination 1. In case of an image from eight views (eight-channel display), the condition D=m (BE/8A) applies to the distance D between the wavelength filter array 3 and the image display device 1, where B is the period of the wavelength filter array 1, E the observer's distance, A the mean interpupillary distance of the observer 7, and m a natural number. The period B corresponds to the distance at which the succession of light-transmitting and opaque filter elements repeats itself, or to the distance between the centers of the areas of two light-transmitting filter elements in a row. If the subpixel period C is given, which is the distance between the area centers of two adjacent filter elements, the value of the period B at m=1 can be calculated by the equation B=8AC/(A−C). For computing D, E should be given an initial value that is much greater than the upper limit of the desired observation space, so that a sufficiently great distance D is ensured. Once values for D have been calculated in this way, and if C and A are known, one can calculate observer distances Eₘ and associated periods Bₘ by substituting various values for m in the equations Eₘ=D (A−mC)/(mC) and Bₘ=8AC/(A−mC), and implement these observer distanced and periods in such a way that they are constant along a row in the filter array 3. The natural number m has to be greater than 1 and, in this example, must not be an even multiple of 8. Each of these periods Bₘ corresponds to an observer distance Eₘ that is substantially closer to the image display device 1 than the original distance B. The period Bₘ need not be the same for all rows; rather, a filter array 3 may comprise various periods, and the observer 7 can choose between observation from several planes. With a distance between wavelength filter array 3 and image display device 1 of D=12.3 mm—which is sufficient for accommodating a second light source 4—and an interpupillary distance of 65 mm, and with a subpixel period of 0.1 mm in a depth range between 38.8 mm and 87.8 mm, there result eleven observation planes where an observer 7 can perceive an excellent three-dimensional image. The original distance E calculated for m=1 is 8 m, by comparison.

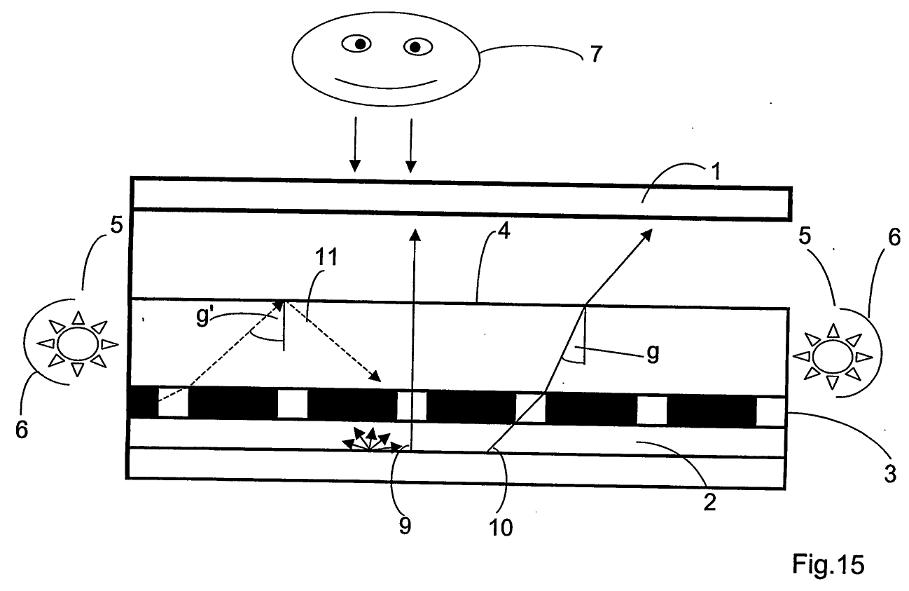

In a further development of the embodiment example described above, an optically active material, preferably a filter plate, is arranged between the first light source 2 and the second light source 4, by means of which light of the first light source 2 having angles of incidence greater than the critical angle of the second light source 4 does not essentially get into the second light source 4. This relationship is shown schematically in FIG. 15. The filter plate virtually corresponds to the wavelength filter array 3, which is a few millimeters (e.g., 1 mm) thick. In that way, a vignetting of the light rays is achieved as described above: Light of the first light source 2 having angles of incidence greater than the critical angle of the second light source 4, does not essentially get into the second light source 4, i.e., the light guide. The thickness of the filter plate, or of the wavelength filter array 3 forming it, has an order of magnitude that is approximately equal to the dimension of the light-transmitting filter elements on filter array 3.

As FIG. 15 shows, the said vignetting prevents light beams of the first light source 2 that have angles of incidence greater than the critical angle of the second light source 4 enter the latter. If, for the light guide forming the second light source 4, the critical angle is, for example, 41°, the light rays 11, shown as broken lines in FIG. 15, which have angles of g′>41°, will be vignetted and not enter the light guide because of the said vignetting, whereas the light rays 9, 10, shown as solid lines, will. In particular, the light ray 10, for example, would enter the light guide or hit its large surface that faces the image display device 1, at an angle g, which is equal to or smaller than the critical angle (in this example, 41°). The advantage of preventing light rays originating from the first light source 2 from entering the light guide above the critical angle is mainly that disturbing reflections are avoided and thus the contrast in the second mode of operation (2D) is further improved. This is, in effect, an automatic reduction of contrast.

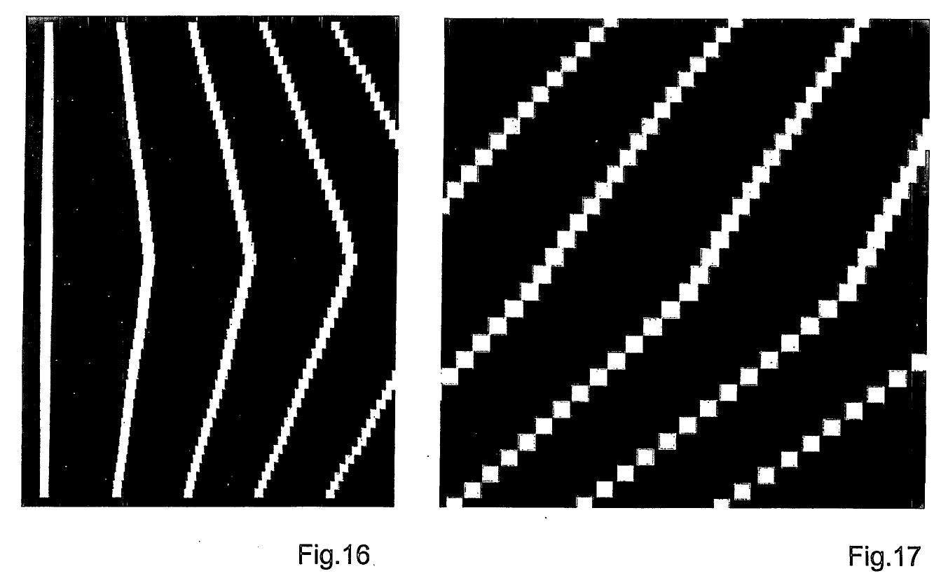

FIGS. 16 and 17 are schematic illustrations (not to scale) of other feasible embodiments of the filter arrays, in which again the influencing of light outcoupling from the light guide (whose opaque filter elements are provided with interfering particles) is connected with the influencing of the given light propagation directions by the filter array structure, this connection being essential to the function. In the examples illustrated by FIGS. 16 and 17, the width of the filter elements that are transparent to light of specified wavelength ranges, or their number (in case they are always of approximately equal size) varies from row to row. On the upper and lower margins, the resultant transparent filter areas are narrower, whereas their width increases towards the middle where they reach a common maximum. This makes it possible, in the sense of the mode of operation of the arrangement described here, to obviate the need to provide a suitable luminance gradient of the first light source 2, as the variation of the transparent filter areas essentially ensures a uniformity of the light rays originating from the first light source 2 and passing through the wavelength filter array 3 with regard to their measurable luminance on the surface of the wavelength filter array 3 facing the image display device 1.

When the filter arrays 3 according to FIGS. 16 and 17 are used, it is of advantage if the image combination structures of the image display device 1 embody periods of the views that differ from row to row, or from one group of rows to the next group of rows. For example, 8 horizontally adjacent image rendering elements in a first row may render image information from views 1-8 in this order, with the period from 1 through 8 being constantly repeated (up to the edge of the screen). The next row, or the next group of (e.g., 5) rows could render, between every four periods of views 1 through 8, a separate period of image information from views 1 through 9, etc.

Besides the wavelength filter arrays and image combinations shown here, it is also possible to use image combinations in which complete rows or columns receive image information from a single view only. The respective rows or columns are then provided with light-transmitting filter elements. In this way, brightness in the first mode of operation can be increased.

It is essential that, with the filter elements on the wavelength filter array 3, light propagation directions for the image information rendered there are always defined in such a way as to provide a spatial impression for the observer.

This embodiments described just now have the special advantage that, in the 2D mode, an almost homogeneous illumination of the image display device 1 can be achieved, the contrast of which approximates zero. Furthermore they permit, in the sense of the invention, the generation of a 3D impression simultaneously for several observers with non-aided eyes in the 3D mode.

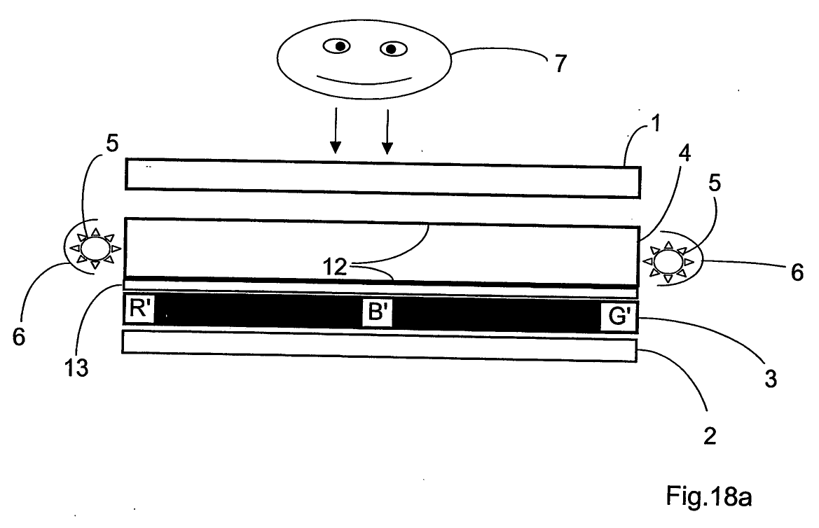

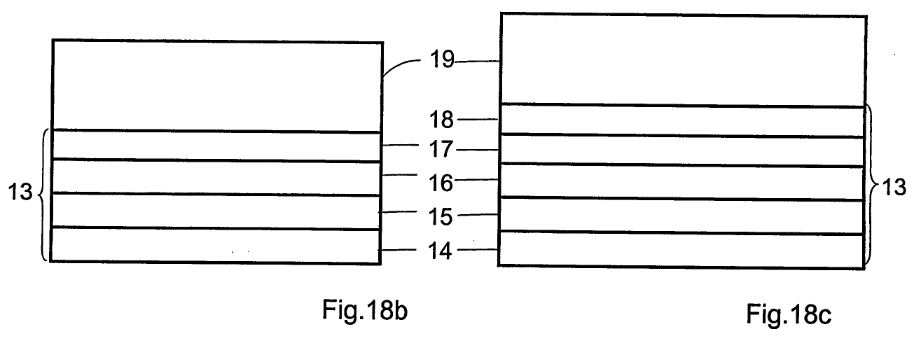

FIG. 18a shows the principle of a second embodiment of an arrangement according to the invention, comprising an image display device 1, a first light source 2, a wavelength filter array 3, a second light source 4 and a light outcoupling structure 13. The second light source 4 is designed as an optical waveguide slab (light guide) with two large surfaces 12 opposite to each other. Light is fed to the light guide by several laterally arranged light sources 5. According to the invention, the light outcoupling structure 13 may be attached to one or both of the large surfaces 8; in the example shown it is attached to the large surface facing away from the observer.

FIG. 18a further shows reflectors 6 intended to improve the utilization of the light emitted by the light sources 5. The light outcoupling structure 13 can be switched on and off and is preferably a switchable scattering layer. As shown in FIG. 18b, for example, this layer may consist of a succession of layers applied on top of the second light source 4, which is designed as an optical waveguide slab (light guide), the first layer being a ITO layer 17, followed by a liquid crystal layer 16, another ITO layer 15 and a top layer 14, e.g., a PET foil or a foil consisting of some optical plastic. As an alternative, as shown in FIG. 18c, it is also possible to insert another substrate layer 18 made of optical plastic and having a higher refractive index than that of the light guide. Unlike PET, optical plastics have no volume scatter or absorption and are free of optical birefringence. In the case described, the sandwich of components 14 through 18 corresponds to a complete switchable scattering disk, which may, for example, be laminated onto the light guide. The switchable scattering layer or light outcoupling structure 13 may be a thin switchable scattering film (preferably about 0.5 mm thick) of the type “Polymer Dispersed Liquid Crystal (PDLC) Film” made by Sniaricerche (Italy). With this design approach, the arrangement according to the invention can easily be implemented with commercially available components.

Further it is of advantage if the opaque filter elements of the wavelength filter array 3 are, on the side facing the observer, diffusely scattering, e.g. provided with a matte white coat of paint. Light coupled out on the side facing the filter array 3 will then be scattered back diffusely.

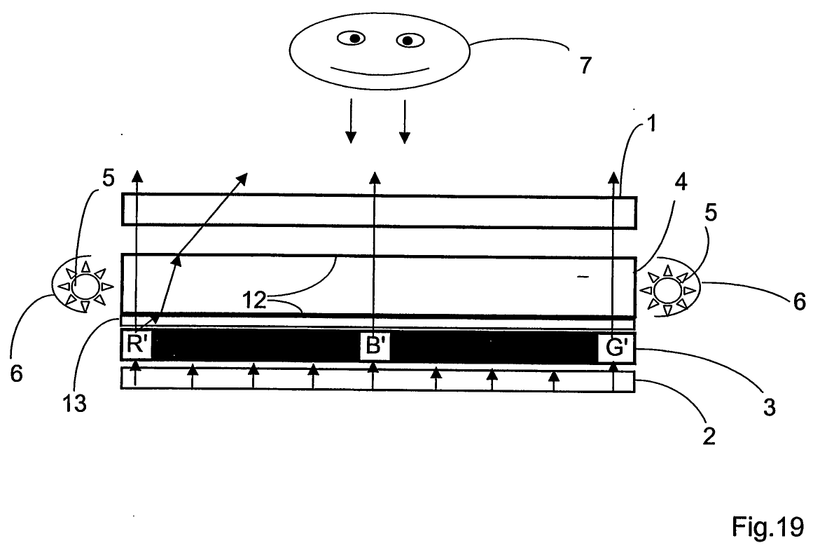

FIG. 19 shows the principle of the first mode of operation of the second embodiment of arrangements according to the invention. The light outcoupling structure 13 designed as a switchable scattering layer is switched to be transparent in the first mode of operation. Thus, the light originating from the first light source 2 passes through at least part of the light-transmitting filter elements of filter array 3 and subsequently through a correlated part of the image rendering elements of the image display device 1 and on to the observer, so that the scene or object appears three-dimensional to the observer. The method of creating the observer's spatial impression has been described in the present applicant's WO 01/56265 (already cited above) and need not be explained here in detail.

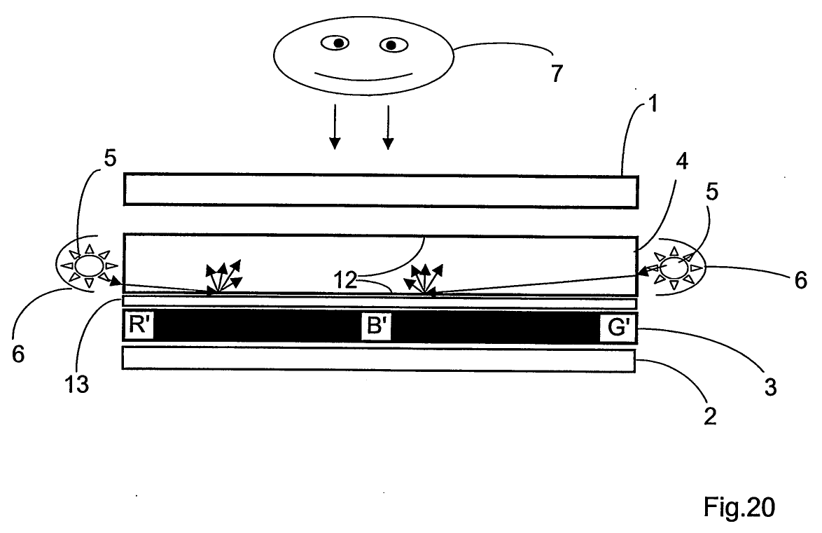

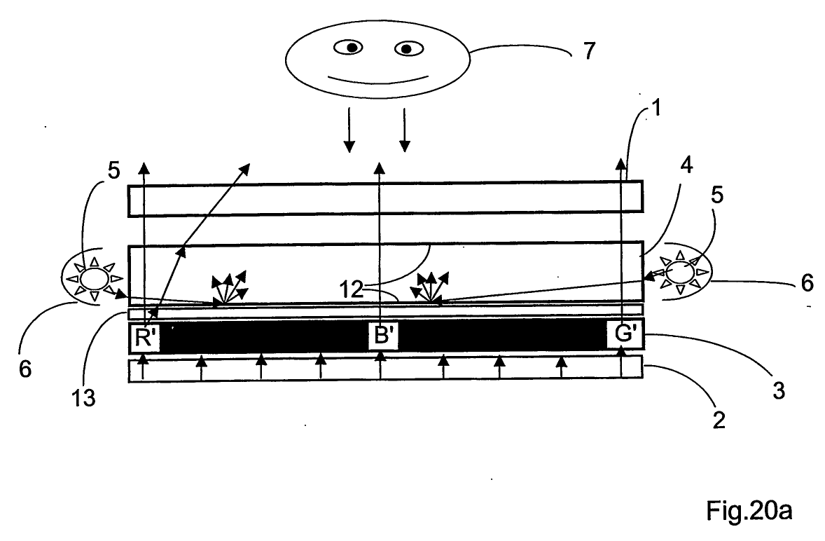

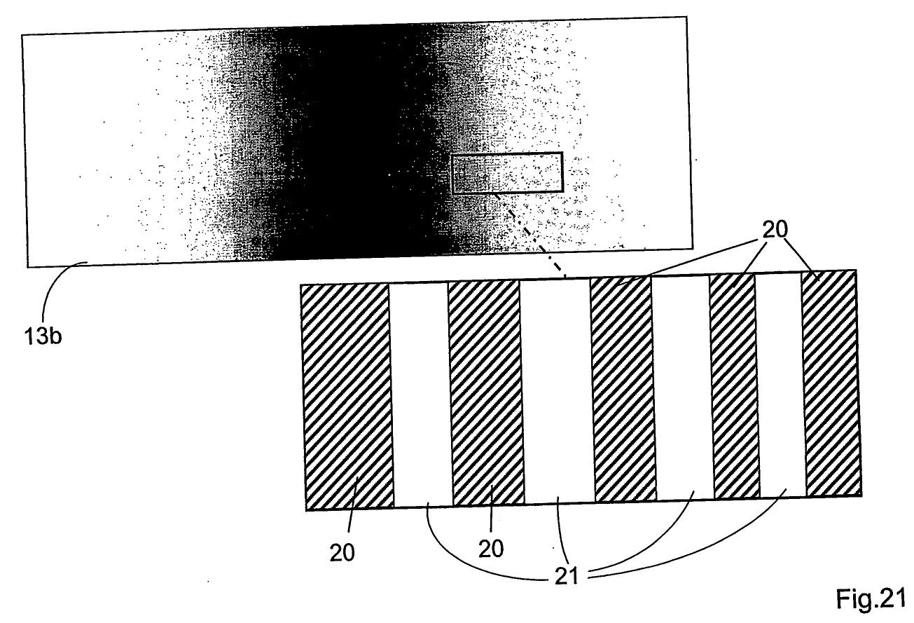

The principle of the second mode of operation is illustrated by FIG. 20. Here, the light outcoupling structure 13 designed as a switchable scattering layer is switched to be scattering, at least over part of its area but preferably over its full area. The latter corresponds to the case that a two-dimensionally perceived image can be displayed on the entire imaging surface of the image display device 1. As the switchable scattering layer acts as a light outcoupling structure 13 in this mode, a very largely homogeneous illumination of the image display device 1 can be achieved for the two-dimensional display. Unlike the arrangement shown in FIG. 2, the light outcoupling structure 13 designed as a switchable scattering layer may also be arranged on the large surface 12 facing the image display device 1 and the observer, of the second light source 4 embodied by the light guide 19, or even on both large surfaces 12 of the light guide 19. In the former case, the homogeneity of luminance distribution in the second mode of operation is extremely good, and image brightness is better, too, because of the light feedback into the light guide 19.

In the second mode of operation, the first light source 2 is preferably switched on in addition to the second light source 4, to achieve an illumination of the image display device 1 with the lowest possible contrast (preferably K=0). In principle, the light of the first light source 2 and that of the second light source 4 supplement each other, resulting in an illumination of very largely homogeneous luminance. This is shown schematically in FIG. 20a.

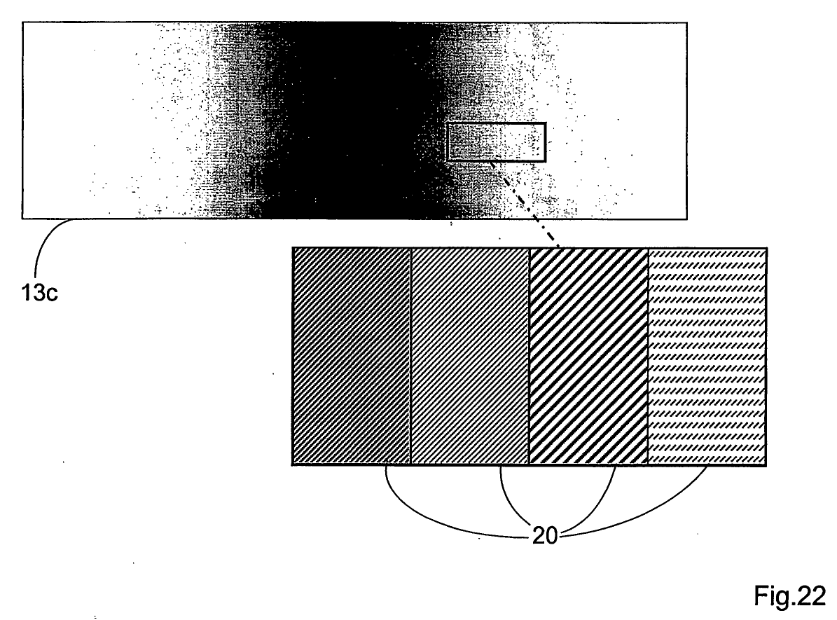

FIG. 21 shows the principle of a particular embodiment of the switchable light outcoupling structure 13, which ensures that the degree of light outcoupling from the second light source 4 embodied by the light guide 19, per sufficiently large unit area, varies for different locations on the light guide 19. Here, “13b” is meant to be a schematic illustration of the light outcoupling structure 13 embodied by a switchable scattering layer; the darker areas have a higher degree of light outcoupling than the brighter areas.

In the second mode of operation of this embodiment, stripe-shaped partial areas 20 of the switchable scattering layer are switched to be scattering, with every two adjacent stripe-shaped partial areas 20 on the switchable scattering layer being separated by permanently transparent stripe-shaped partial areas 21, so that the degree of light outcoupling from the light guide 19 per unit area varies with location on the light guide 19. In other words, the local degree of light outcoupling is determined by the local variation of the width and local frequency of the stripe-shaped partial areas 20 of the switchable scattering layer (“geometric adaptation of the degree of light outcoupling” with the aim of homogenizing the luminance). This again makes it possible to achieve a more homogeneous overall illumination thanks to the second light source, for example, if the degree of light outcoupling close to the laterally arranged light sources 5 used for inward light coupling is lower than it is at some distance from them.

FIG. 22 shows the principle of another particular embodiment of the switchable light outcoupling structure 13, which also ensures that the degree of light outcoupling from the light guide 19 per unit area varies for different locations on the light guide. Here, “13c” is meant to be a schematic illustration of the switchable scattering layer, in which the darker areas have a higher degree of light outcoupling that the brighter areas. In the second mode of operation of this embodiment, the switchable scattering layer is switched to be scattering in different degrees for different locations, so that the degree of light outcoupling from the light guide 19 also differs with location on the light guide 19. To achieve different degrees of scattering at different locations of the switchable scattering layer, pairs if different control voltages are applied to stripe-shaped partial areas 20 of the scattering layer which are preferably electrically isolated from each other. The various control voltages can be applied via diverse electrode pairs. An electrical control device (not shown in the drawing) is provided for the simultaneous application of different voltages. The different hatchings or textures of the partial areas 20 represent differing degrees of scattering.

This last-described “electric adaptation of the degree of light outcoupling” can also be combined with the previously described geometric adaptation to achieve particularly homogeneous 2D illumination.

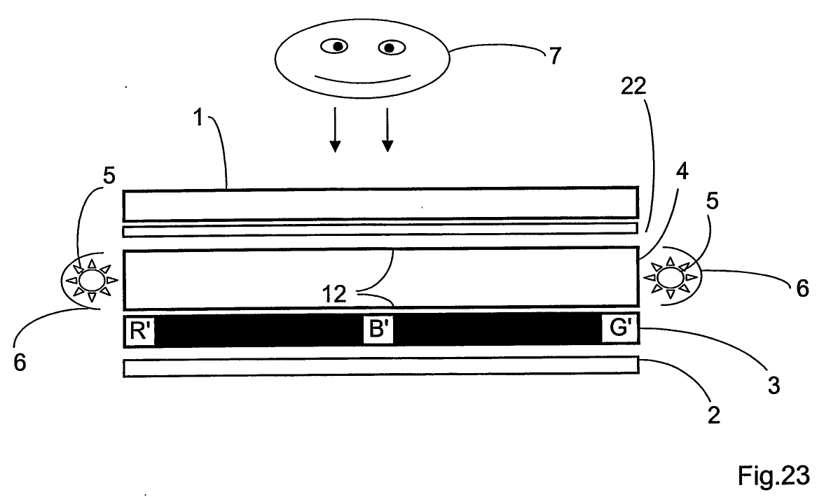

FIG. 23 shows the principle of a third embodiment of arrangements according to the invention. Here again, the second light source 4 is configured as an optical waveguide slab (light guide) 19 with two large surfaces 12. Arranged between the light guide 19 and the image display device 1 is a switchable scattering disk 22, which is switched to be transparent in the first mode of operation and, with at least parts of its area, scattering in the second mode of operation, so that the brightness contrast of the light passing the switchable scattering disk 22 in the second mode of operation is reduced.

The last-named contrast reduction homogenizes the illumination in the second mode of operation, i.e. the mode for two-dimensional display. The light guide 19 used here may be of a conventional type, preferably one with a special light outcoupling structure. In a modified form, the said light outcoupling structure is formed only on those partial areas of the light guide 19 that, in case of projection along a direction normal to the large surfaces 12, correspond to the opaque filter elements.

In this arrangement, too, the first light source 2 may b switched on in addition to the second light source 4 in the second mode of operation so that more light is available. Because of scattering disk 22, switched to be scattering, this additional light of the first light source 2 has no influence on the homogeneity of the light used for the illumination of the image display device 1.

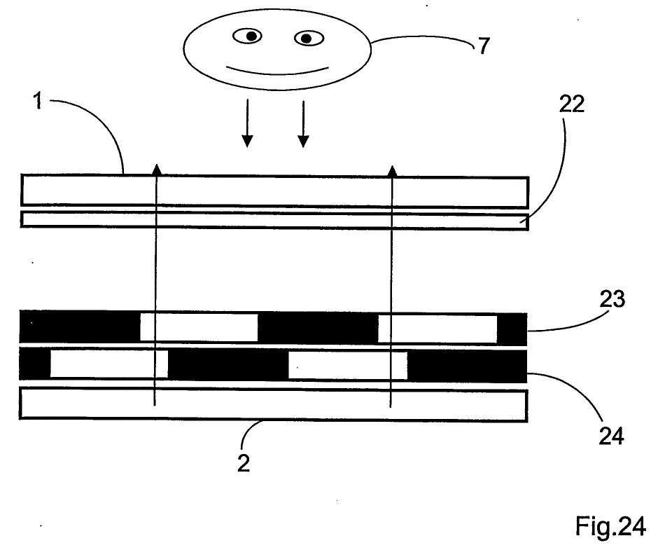

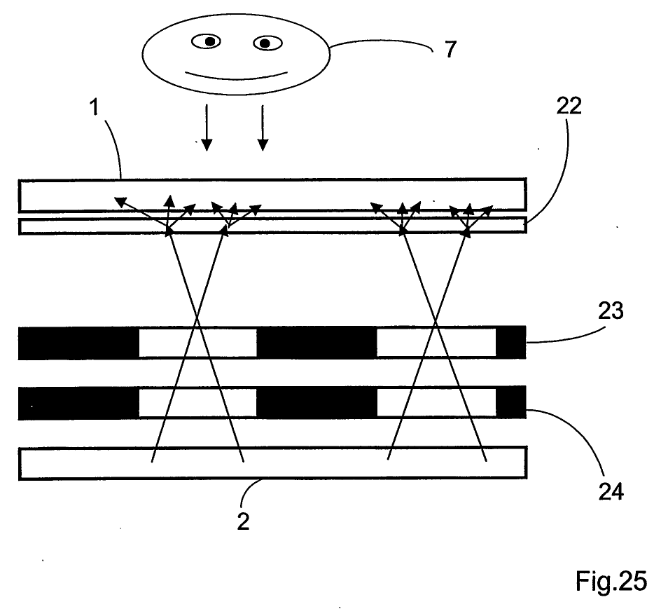

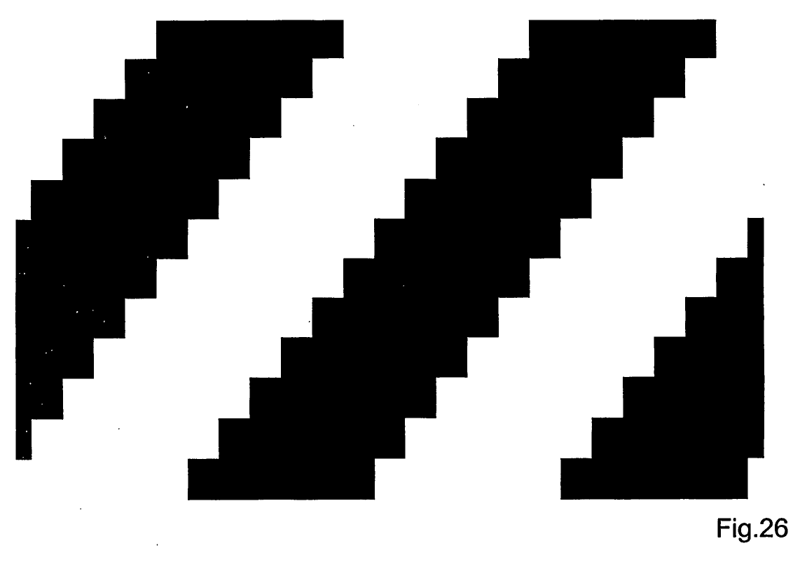

Further, FIGS. 24 and 25 illustrate the principle of a fourth embodiment of arrangements according to the invention, with FIG. 24 showing the first mode of operation, and FIG. 25 the second mode of operation.

This again is an arrangement for the display of images of a scene or object, which differs by being provided with two plane wavelength filter arrays 23, 24 arranged behind the image display device 1 (in the viewing direction of an observer 7). Each of the two wavelength filter arrays consists of a multitude of filter elements arranged in rows and/or columns. Part of these filter elements is transparent to light of specified wavelength ranges, whereas the remaining part is opaque to light. One of the two wavelength filter arrays 23, 24 can be shifted relative to the other, and they are preferably in close contact with each other. Arranged between the wavelength filter arrays 23, 24 and the image display device 1 is a switchable scattering disk 22, which is switched to be transparent in the first mode of operation and, with at least parts of its area, scattering in the second mode of operation.

In the first mode of operation shown in FIG. 24, the wavelength filter arrays 23, 24 have such a position relative to each other that the light emitted by the light source 2 arranged behind the wavelength filter arrays 23, 24 passes through at least part of the light-transmitting filter elements of both wavelength filter arrays 23, 24 and subsequently through a correlated part of the image rendering elements of the image display device 1 and on to the observer, so that the observer sees a three-dimensional image of the scene or object.

In the second mode of operation shown in FIG. 25, the switchable scattering disk 22—or at least parts of its area—are switched to be scattering, and the wavelength filter arrays 23, 24 have such a position relative to each other that, in contrast to the first mode of operation, more light is passed through the light-transmitting filter elements of both wavelength filter arrays 23, 24 and subsequently through the scattering disk 22, switched to be scattering in the second mode of operation, through the image rendering elements of the image display device 1 and on to the observer, so that the observer sees a two-dimensional image of the scene or object.

As a rule, a distance of a few millimeters between the switchable scattering disk 22 and the wavelength filter arrays 23, 24 is sufficient. “Sufficient” means that the scattering disk 22 is located far enough from the wavelength filter arrays 23, 24 for being capable of diffusing their (usually) visible structures in such a degree that these structures can no longer be resolved visually.

In general, even more than two wavelength filter arrays 23, 24 with a (total) number W may be provided, of which at least W-1 wavelength filter arrays can be shifted.

Preferably, the shifting of each shiftable wavelength filter array 23, 24 is intended to take place along the rows of the raster of image rendering elements of the image display device 1.

With particular preference, the length of displacement of each shiftable wavelength filter array 23, 24 is smaller than the horizontal period of the light-transmitting filter elements provided on the respective wavelength filter array 23, 24, if such a period is provided. This circumstance has been allowed for in FIGS. 24 and 25, i.e., the intended displacement of the lower filter array 24 is about three eighths of the said period.

The displacement of each shiftable wavelength filter array is performed by a mechanical control element, for example, a piezoelectric positioner, which is not shown in the drawing.

As an example, FIG. 26 shows a detail (not to scale) of a structure of two wavelength filter arrays 23, 24 intended for use in the currently discussed embodiment of arrangements according to the invention. The dimensions may be as follows, for example: Either filter array 23, 24 has an overall width of approximately 310 mm and an overall height of approximately 235 mm. Each row of a filter array 23, 24 is approximately 0.30086 mm high. The width of each transparent and opaque segment per row is approximately 0.40114 mm. The offset between the transparent or opaque segments of a row and the transparent or opaque segments of an adjacent row is 0.066857 mm. Such a filter array is, for example, highly suitable for use in conjunction with a 15.1″ LCD of the LG make.

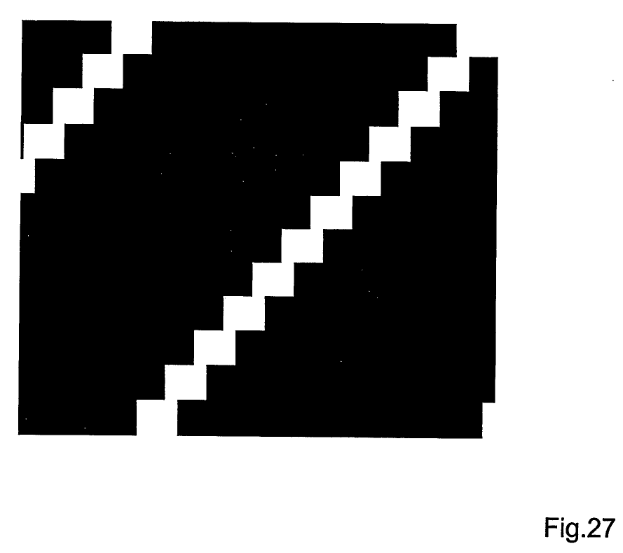

FIG. 27 shows the summary effect of two equal filter arrays 23, 24 according to FIG. 26, shifted relative to each other, for use in the first mode of operation. The amount of horizontal shift between the filter arrays 23, 24 is about 0.30086 mm. As described above, the switchable scattering disk is switched to be transparent in this mode. Eligible for image display on the image display device 1 is a suitable image combination structure, e.g., that shown by FIG. 53 in DE 20121318 U.

For the second mode of operation, the two filter arrays 23, 24 may, for example, be located without a shift relative to each other, i.e., in sum they look about the same as in FIG. 26. The scattering disk 22 is now switched to be scattering, so that a homogeneous illumination of the image display device 1 is achieved.

In most of the cases described before, the filter elements of the wavelength filter array 3 have a non-negligible spatial extension in depth along the observer's viewing direction. If the opaque filter elements are completely coated with a material that diffusely scatters white light and has an absorption coefficient as low as possible (“completely” meaning both on the side facing the observer and on the side faces oriented along the viewing direction of the observer), this will lead to a direct, automatic contrast reduction in the first mode of operation. If any light ray falls onto the diffusely scattering side faces under an unfavorable angle, it enters this coat of material and effects a brightening there. Therefore it is desirable that this material coat is as thin as possible and/or has reflective-opaque edges.

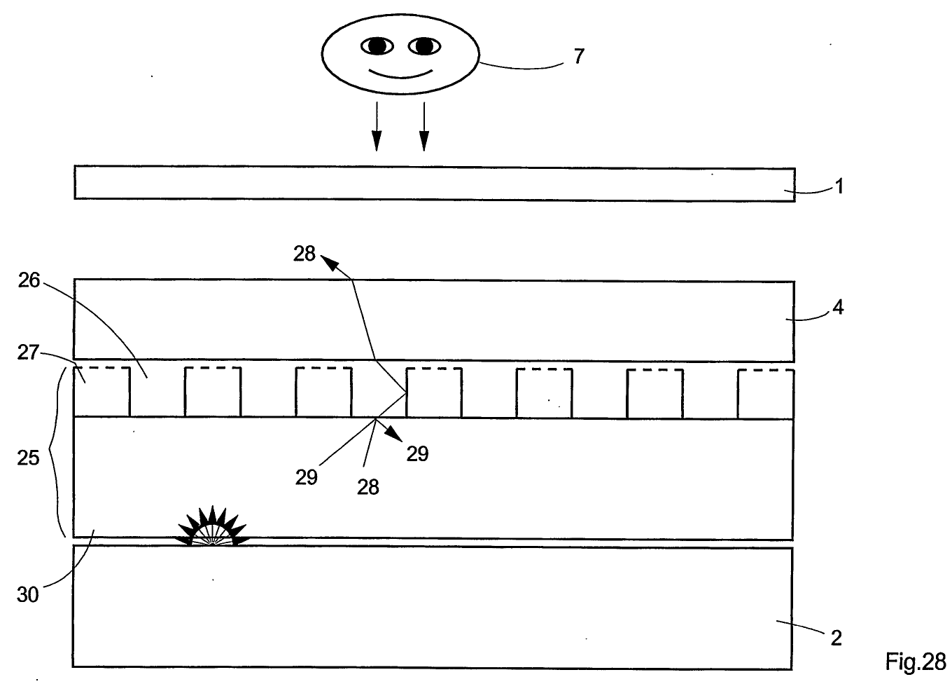

The wavelength filter array shown in FIG. 28 allows the contrast reduction to be avoided. Shown greatly enlarged and not to scale with the other components is a wavelength filter array 25 with light-transmitting filter elements 26 and opaque filter elements 27 on a substrate 30. The opaque filter elements 27 are coated with the diffusely scattering material on the side facing the observer. Here, the side faces are coated with a reflecting material, so that a light ray 28 cannot enter the filter elements 27. Therefore, the reflected light leads to a higher brightness of the image, in both the first and second modes of operation. The light beam 29 is totally reflected within the substrate 30; the substrate of the wavelength filter array 25 should preferably be an optical material with low volume absorption.

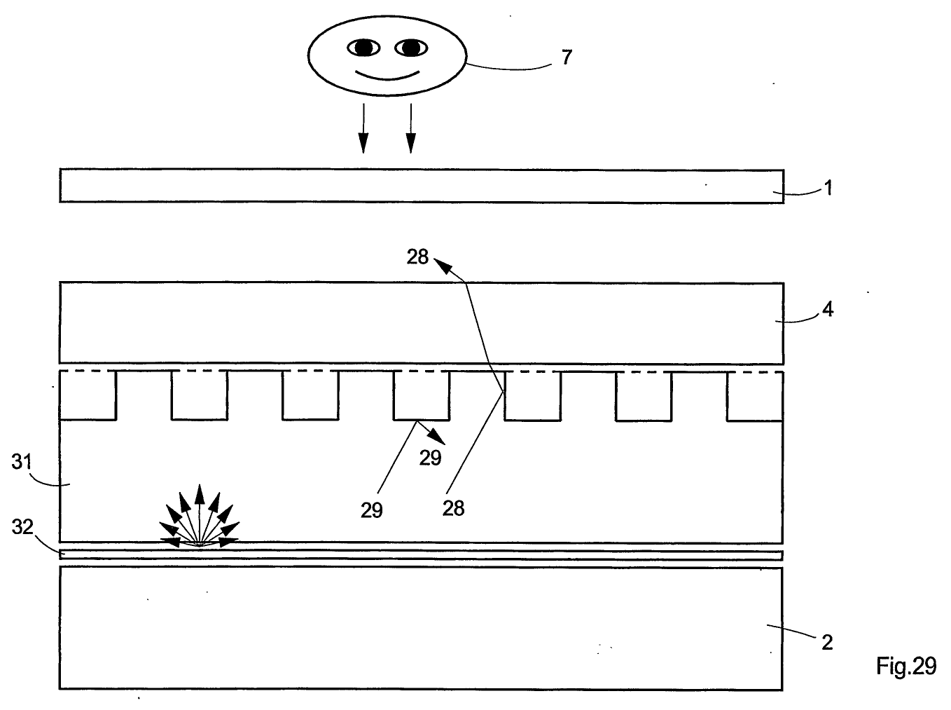

FIG. 29 shows another way to reduce contrast. The illustration shows a wavelength filter array 31 made of one solid piece, in which the obliquely incident light rays 28 from the first light source 2 are totally reflected off the side faces and then, analogously, leave the wavelength filter array 31 at the top, where, at the interface with air, their angle of incidence is smaller than the critical angle. In this example, contrast is further reduced by the use of a brightness-increasing layer 32, such as a Brightness Enhancement Film made by 3M, by means of which the luminance of the first light source is influenced in such a way that within a certain angular range facing towards the observer it is distinctly greater than in lateral directions, which is marked in FIG. 29 by arrows of different lengths.

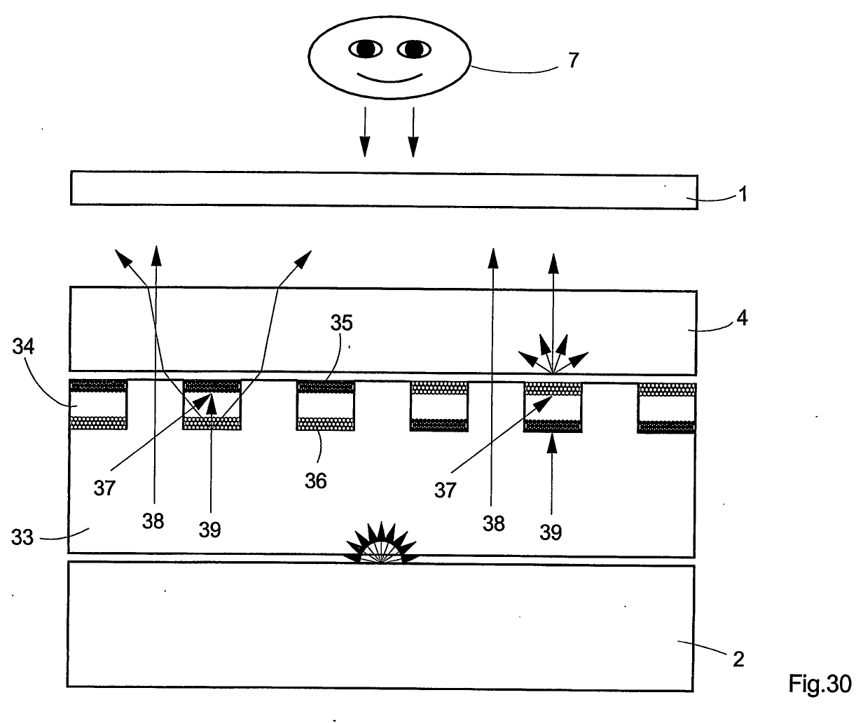

FIG. 30 shows yet another way to reduce contrast. Shown here is a switchable electrophoretic wavelength filter array 33, whose opaque filter elements 34 have two operating statutes corresponding to the two operating modes. In the first mode of operation (for three-dimensional display), the filter elements, seen from the observer's direction, appear light-absorbing; in the second mode of operation they are reflecting the light coming, e.g., from the second light source 4, also seen from the observer's direction. These two operating modes can be implemented if the principle of electrophoresis, i.e., the migration of colloidal, charged particles in a direct electrical field is made use of for the design of the filter elements 34. The principle has long been known, but has been used only for printing on paper so far. In FIG. 30, the three filter elements 34 on the left are shown in the first mode of operation, whereas the three filter elements 34 on the right are shown in the second mode of operation. A filter element 34 contains two kinds of particles of different polarity, embedded in an optically transparent liquid. The two kinds of particles may be, for example, black particles 35 with a positive charge and white particles 36 with a negative charge. The particles have to be selected in such a way that the black particles in toto have a sufficient optical density (absorbance) and the white particles in toto have a high diffuse reflectance (degree of scattering). Moreover, they have to permanently retain their electric charges, but they need not all be of the same kind, although they are shown so for the sake of clarity. Although the filter elements 34 are shown square in FIG. 30, they may have the shape of any other polygon or be of hemispherical or spherical shape.

If one applies a negative, voltage to transparent electrodes on the side of the filter elements 34 that faces away from the observer, and a positive voltage to such electrodes on the side facing the observer, the opaque filter elements 34 are switched as needed for the first mode of operation. If the polarity of the voltages is reversed, the filter elements are switched as needed for the second mode of operation. The particles 35, 36 migrate to the respective electrodes according to their charging condition. Switching between the first and second modes can be accomplished in a very short time, i.e. shorter than the display refresh times on current LCD screens, which are about 16 ms.

Three light rays 37, 38, 39 symbolize the optical conditions. Light ray 38 passes the light-transmitting filter elements without hindrance in both operating modes. Light ray 37 is absorbed in the first mode of operation (3D); there is no direct contrast reduction. In the second mode of operation, light ray 37 passes the diffusely scattering layer and, due to multiple scattering, is split into many light rays which contribute to an increase in image brightness in the 2D mode. The conditions are different also for light ray 39: It is absorbed in the second mode of operation, whereas in the first mode of operation the diffusely scattering layer splits it up into several light rays, which then leave the filter element 34 in different directions and contribute to an increase in the brightness of the 3D image.

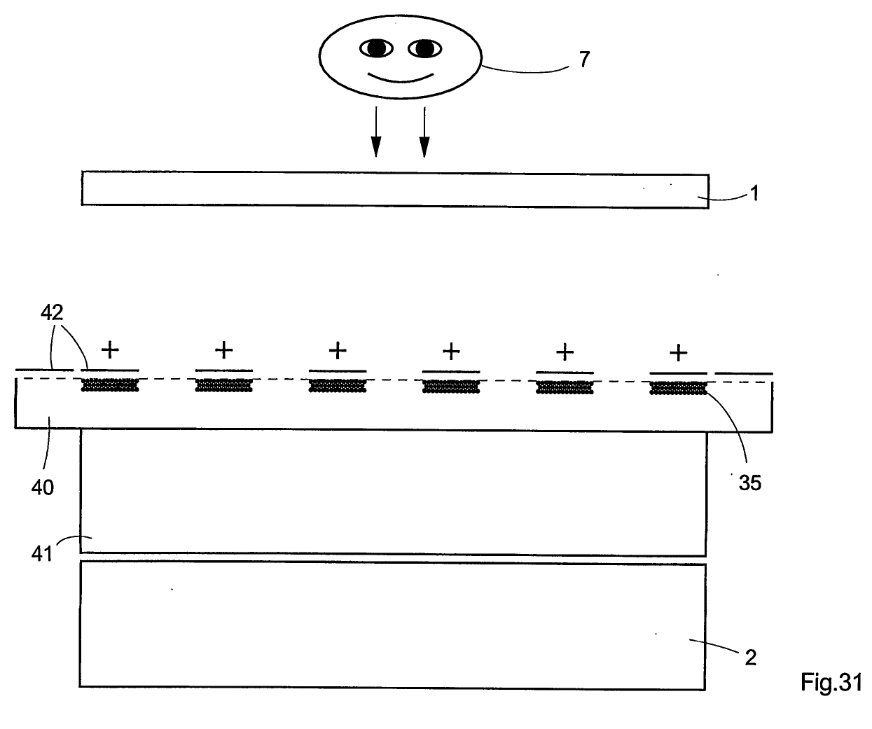

FIG. 31 shows a possibility to do without the second light source 4. In this embodiment example, a wavelength filter array 40 is provided that can be switched off completely; here, it is applied on a transparent filter substrate. The wavelength filter array 40 also operates on the electrophoretic principle. Inside it there is a transparent liquid layer containing black particles 35. In the example shown, the particles are charged negatively, but their charge may just as well be positive. In the first mode of operation (as shown), the particles 35 are fixed in the vicinity of a positive electrode 42, which is shown to be on the side facing the observer but may just as well be on the other side. The negative electrode is not shown. On the right and left, the filter array 40 slightly juts out from the other components; in the areas that jut out there are the so-called collection areas, because here the black particles collect in the second (2D) mode of operation, in which the filter array is completely transparent.

To switch the wavelength filter array from the first to the second mode of operation, those electrodes 42 lying closest to the center can be switched off first. Simultaneously, the voltage in the electrodes 42 surrounding the central ones is increased by approximately the amount corresponding to the “on” voltage of the electrode 42 that is now off, i.e. at least approximately the same charge quantity as that originally fixed to the now switched-off electrode 42. The black particles 35 then migrate to the electrode 42 whose voltage has been increased. This process is continued until all particles are at the electrodes 42 closest to the collection areas. Only now is a positive voltage applied to the collection areas, while simultaneously the voltage at the electrodes 42 presently harboring the black particles 35 is reduced to zero, so that all particles 35 migrate to the collection areas, where they are fixed electrostatically. Switching from the second to the first mode of operation is effected analogously. Under certain circumstances it may be necessary to use alternating fields to permit a quick reversal of the polarity of the electrodes.

As this embodiment does not need a second light source 4 (or light guide) before the wavelength filter array (as seen from the observer's viewpoint), there is no contrast reduction, and image quality is high in both modes of operation.

Instead of the electrophoretic migration of charged particles, such a wavelength filter array may utilize another effect, which leads to so-called suspended particle devices. This method uses light-absorbing, colloidal particles having a dipole moment induced in an electric field. With the field switched off, the dipole moments of these particles are oriented at random, and an accumulation of such particles is opaque. Upon the application of an alternating electric field, the dipole moments get aligned, and particle accumulation gets transparent. In this way, the collection areas mentioned above can be done without.

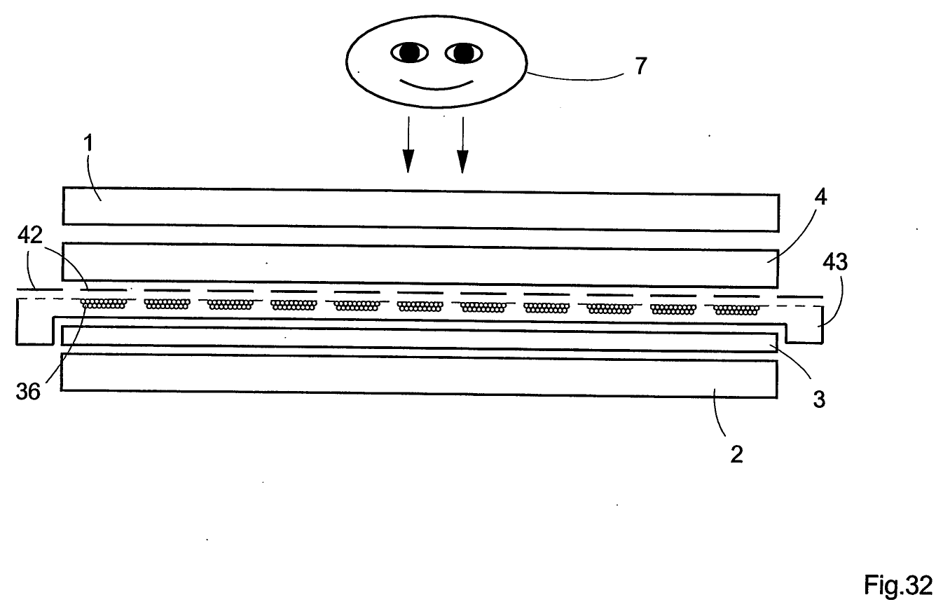

The electrophoretic principle can also be applied to reduce, in case of 2D display, the contrast enhancement caused if the 3D illumination is switched on. An example of an embodiment using this facility is shown in FIG. 32. Between the wavelength filter array 3 and the second light source 4, an optically scattering foil 43, designed as an electrophoretic component, is provided, which preferably diffusely reflects, or re-emits, white light, and the scattering effect of which is due to an accumulation of white particles 36, which in the second mode of operation are distributed, if possible, over the complete area of the foil, so that they scatter light originating from the second light source 4 by diffuse reflection and scatter light originating from the first light source 2 by diffuse transmission. The procedure to switch into the first mode of operation is analogous to the description given for FIG. 31.

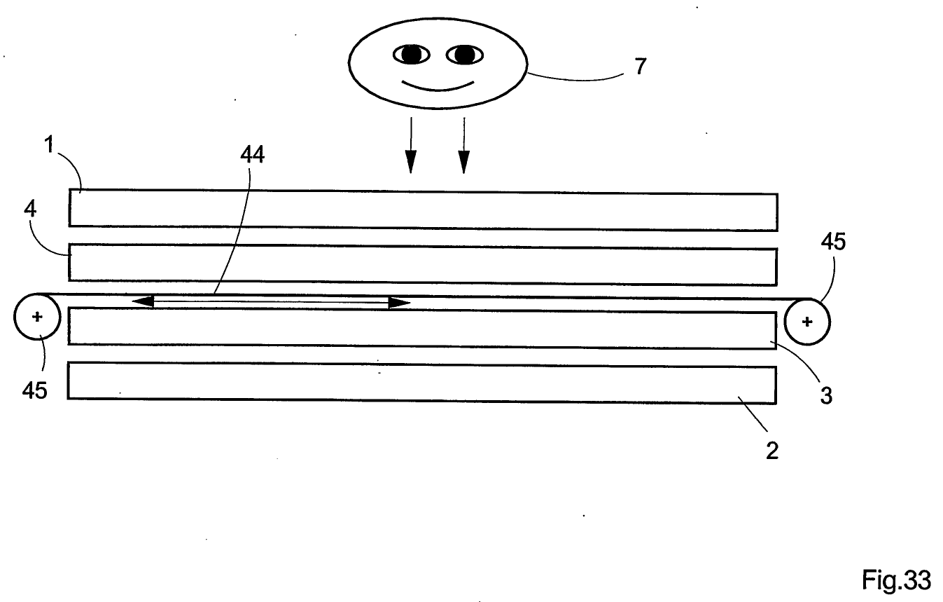

In a simplified embodiment, the positioning or removal of the foil (for switching to the second or first mode of operation, respectively) can be effected mechanically, i.e., either manually or by means of a motor. Such an example is shown in FIG. 33. To the right and left of the arrangement there is a winding and unwinding mechanism 45, which can be actuated manually or by a motor, which may even be program-controlled. An optically scattering foil 44 may then, for example, in the 3D mode be wound into a roll located at the top or on one side of the screen, from where it can be unwound in the 2D mode so as to move, along lateral guide rails, in a narrow, light-tight and dust-tight slit between the wavelength filter array 3 and the second light source 4.

Further, it may be of advantage for each of the above-described embodiments of the arrangements according to the invention if, in the first mode of operation (for three-dimensional display on at least part of the area), each of the observer's eyes predominantly but not exclusively sees a particular selection of the displayed bits of image information from several perspective views of the scene or object, so that the observer has a spatial impression. Examples for the creation of a spatial impression under this condition are described, e.g., in DE 20121318 U (cited above), and in WO 01/56265 and WO 03/024122 of the present applicant.

As a matter of course, the image displayed in the second mode of operation should merely be a two-dimensional image rather than one composed of several views, which can easily be accomplished by suitable control of the image display device.

In an equivalent variation of the theory described herein, an existing filter array may occasionally be replaced with a barrier screen, a lenticular or other optical components, including such with holographic-optical elements.

Let it be pointed out expressly that someone skilled in the art may combine the characteristics and features disclosed in this application in further variations not explicitly described herein. No such variations shall fall outside the scope of the invention claimed herewith.

1. An arrangement for displaying images of a scene or object,
comprising an image display device comprising a multitude of light-transmitting image rendering elements, which are arranged in a raster of rows and/or columns and on which bits of image information from several perspective views of the scene or object can be displayed,
and comprising a plane wavelength filter array, which is arranged behind the image display device, and comprising a multitude of filter elements arranged in rows and/or columns, part of which are transparent to light of specified wavelength ranges, whereas a remaining part are opaque,
and comprising a controllable illuminator providing at least two modes of operation, in which
in a first mode of operation, light from a first light source arranged behind the wavelength filter array reaches the observer by passing through at least part of the light-transmitting filter elements and subsequently through a correlated part of the image rendering elements of the image display device, so that the scene or object is seen by the observer in three dimensions, and in which
in a second mode of operation, light from a second light source having at least one emission plane that is arranged between wavelength filter array and image display device and that is essentially parallel to the wavelength filter array, leaves the said at least one emission plane and reaches the observer by passing through the image rendering elements of the image display device but not through the filter elements of the wavelength filter array, so that the scene or object is seen by the observer at least partially in two dimensions, and
further comprising a diffuse illuminator in the second mode of operation.

2. An arrangement as claimed in claim 1, in which
the second light source is a planar light source configured as light guide, and in which
the light guide has two mutually opposite large surfaces and peripheral narrow surfaces, and the large surface facing the image display device or away from it corresponds to the emission plane, or both large surfaces correspond to the emission planes, and in which
the light guide receives light from one or several laterally arranged light sources, and in which
the light is coupled into the light guide via one or several of the narrow surfaces, partially reflected back and forth by total reflection off the large surfaces, and partially coupled out at the large surface corresponding to the emission plane or the large surfaces corresponding to the emission planes.

3. An arrangement as claimed in claim 1, in which, in the second mode of operation, the first light source is switched on in addition to the second light source, only the large surface facing away from the image display device is an emission plane, and, to provide uniform illumination, only those areas of the emission plane are intended for light emission that, in case of projection onto the wavelength filter array along a direction normal to the plane, are essentially congruent with the areas occupied by opaque filter elements.

4. An arrangement as claimed in claim 3, in which the wavelength filter array is located at the large surface corresponding to the emission plane.

5. An arrangement as claimed in claim 3, in which the large surface corresponding to the emission plane is, in the areas intended for emission, coated with a structure that interferes with total reflection, the structure comprising a coat of particles.

6. An arrangement as claimed in claim 5, in which the interfering capability of the particles across the emission plane is inhomogeneous, ranging between two limit values that vary with the density of particles in the coating.

7. An arrangement as claimed in claim 6, in which the interfering capability of the particles in each single coated area is essentially constant.

8. An arrangement as claimed in claim 6, in which two parallel, opposite narrow surfaces are intended for inward light coupling, and in which the interfering capability of the coated areas, arranged in stripe-shaped segments aligned in parallel with the narrow surfaces, progressively increases with increasing distances x₁, x₂ up to a common maximum.

9. An arrangement as claimed in claim 5, in which the interfering capability of the particles is essentially homogeneous, both within each of the partial areas and across the emission plane as a whole.

10. An arrangement as claimed in claim 9, in which two mutually opposite, vertical narrow surfaces are intended for inward light coupling, and in which, in selected, non-overlapping areas of the wavelength filter array comprising one or several rows and/or columns each and, together, completely covering the wavelength filter array, the ratio between the surface areas covered by filter elements that transmit light of specified wavelength ranges and the surface areas covered by opaque filter elements is defined depending on the maximally achievable luminance in those partial areas of the emission plane of the planar light source that, in case of projection along a direction normal to the plane, each correspond to one of the selected areas thus selected of the wavelength filter array.

11. An arrangement as claimed in claim 5, in which an essentially light-absorbing layer is provided on top of the coat that interferes with total reflection.

12. An arrangement as claimed in claim 1, in which the controllable illuminator comprises a device to control the first light source so as to create a luminance gradient over the plane of the wavelength filter array.

13. An arrangement as claimed in claim 1, in which the controllable illuminator comprises a first light source that is a discharge lamp provided with a plane sealing glass on the side facing and parallel to the wavelength filter array, and with a phosphor coating provided on the inside of the sealing glass.

14. An arrangement as claimed in claim 13, in which the phosphor coating is only applied on areas that, in case of projection onto the wavelength filter array along a direction normal to the plane, are essentially congruent with the areas covered by filter elements that transmit light of specified wavelength ranges.

15. An arrangement as claimed in claim 13, in which the wavelength filter array is located on the outside of the sealing glass.

16. An arrangement as claimed in claim 1, in which, in the second mode of operation, part of the light of the first light source is coupled out and then re-coupled into the second light source by optical elements, the coupled out part of the light being defined by the ratio between the wavelength filter array's surface areas covered by filter elements that transmit light of specified wavelength ranges and the surface areas covered by opaque filter elements.

17. An arrangement as claimed in claim 16, further comprising light guides, reflecting elements or both of the foregoing for outcoupling and inward coupling.

18. An arrangement as claimed in claim 1, further comprising an optically effective material, comprising a filter plate or a thin foil having a microstructure of prismatic effect, arranged between the first and second light sources, so that light of the first light source having angles of incidence greater than a critical angle of the second light source is essentially prevented from entering the second light source.

19. An arrangement as claimed in claim 1, in which the second light source comprises a great number of separately controllable, individual light sources that radiate light towards the image display device and that, simultaneously, are configured as opaque filter elements in the wavelength filter array.

20. An arrangement as claimed in claim 19, in which the light sources are light-emitting, essentially planar polymer layers.

21. An arrangement for displaying images of a scene or object,
comprising an image display device comprising a multitude of translucent image rendering elements, on which bits of image information from several perspective views of the scene or object can be displayed,
and comprising an array, which is arranged behind the image display device, and which contains comprises a multitude of individually controllable light sources arranged in rows and/or columns and capable of emitting light of specified wavelength ranges, in which
in a first mode of operation, light is emitted by those light sources only whose light reaches the observer through those of the image rendering elements of the image display device that are each assigned to the respective light source, so that a three-dimensional image is displayed, and in which
in a second mode of operation, light is emitted additionally by at least another part of the light sources whose light reaches the observer through image rendering elements of the image display device without any special assignment, so that the image displayed is, at least in part, two-dimensional.

22. An arrangement as claimed in claim 21, in which the light sources are essentially planar, light-emitting polymer layers.

23. An arrangement as claimed in claim 21, further comprising a liquid crystal display as a light source.

24. An arrangement as claimed in claim 2, in which the diffuse illuminator in the second mode of operation comprises a light outcoupling structure that can be switched on and off and is located on at least one of the large surfaces.

25. An arrangement as claimed in claim 24, in which the light outcoupling structure that can be switched on and off comprises a switchable scattering layer.

26. An arrangement as claimed in claim 25, in which the switchable scattering layer is switched to be transparent in the first mode of operation and scattering in the second mode of operation.

27. An arrangement as claimed in claim 26, in which, in the second mode of operation, only partial surfaces of the switchable scattering layer are switched to be scattering.

28. An arrangement as claimed in claim 27, in which the partial areas are stripe-shaped.

29. An arrangement as claimed in claim 28, in which the stripe-shaped partial areas differ in width.

30. An arrangement as claimed in claim 29, in which every two adjacent partial areas that are switched to be scattering are separated by permanently transparent stripe-shaped partial areas, so that the degree of light outcoupling from the light guide per unit area differs from place to place on the light guide.

31. An arrangement as claimed in claim 24, in which the switchable scattering layer in the second mode of operation is switched to have differing degrees of scattering from place to place, so that the degree of light outcoupling from the light guide differs from place to place on the light guide.

32. An arrangement as claimed in claim 31, in which pairs of different control signals are applied to different places on the switchable scattering layer to produce different degrees of scattering in the places.

33. An arrangement as claimed in claim 24, in which the opaque filter elements on the side of the wavelength filter array that faces the observer are diffusely scattering.

34. An arrangement as claimed in claim 24, in which the large faces of the light guide have plane and/or textured surfaces.

35. An arrangement as claimed in claim 24, in which the switchable scattering layer is a liquid crystal layer that is transparent to light if a suitable voltage is applied and that scatters light if such voltage is missing.

36. An arrangement as claimed in claim 2, in which the diffuse illuminator in the second mode of operation is a switchable scattering disk arranged between the light guide and the image display device, this scattering disc being switched to be transparent in the first mode of operation and, at least over part of its surface, scattering in the second mode of operation, so that the brightness contrast of the light passing the switchable scattering disk in the second mode of operation is reduced.

37. An arrangement as claimed in claim 24, in which, in the second mode of operation, the first light source is switched on in addition to the second light source.

38. An arrangement for displaying images of a scene or object,
comprising an image display device comprising a multitude of light-transmitting image rendering elements, which are arranged in a raster of rows and/or columns and on which bits of image information from several perspective views of the scene or object can be displayed,
and comprising at least two plane wavelength filter arrays which are arranged behind the image display device, and each of which consists of a multitude of filter elements arranged in rows and/or columns, part of which are transparent to light of specified wavelength ranges, whereas the remaining part are opaque to light, with one of the wavelength filter arrays being shiftable relative to the other and with both arrays being substantially in close contact with each other,
and comprising a substantially planar light source arranged behind the wavelength filter arrays,
and comprising a switchable scattering disk arranged between the image display device and the wavelength filter arrays, and that is switched to be transparent in the first mode of operation and, at least over part of its surface, scattering in the second mode of operation,
in which, in a first mode of operation, the wavelength filter arrays occupy such positions relative to each other that the light emitted by the light source arranged behind the wavelength filter arrays reaches the observer by passing through at least part of the light-transmitting filter elements of both wavelength filter arrays and subsequently through a correlated part of the image rendering elements of the image display device, so that the scene or object is seen by the observer in three dimensions, and in which
in a second mode of operation, the switchable scattering disk is switched to be scattering at least over part of its area, and the wavelength filter arrays have such positions relative to each other that, compared to the first mode of operation, more light reaches the observer by passing through the light-transmitting filter elements of both wavelength filter arrays and subsequently through the scattering disk that is switched to be scattering in the second mode of operation and through the image rendering elements of the image display device, so that the scene or object is seen by the observer in two dimensions.

39. An arrangement as claimed in claim 38, in which a number W of more than two wavelength filter arrays are provided, at least W-1 of them being shiftable.

40. An arrangement as claimed in claim 38, in which the shifting of each shiftable wavelength filter array takes place in the row direction of the raster of image rendering elements of the image display device.

41. An arrangement as claimed in claim 40, in which the length of shifting of each shiftable wavelength filter array is smaller than the horizontal period of the light-transmitting filter elements provided on the respective wavelength filter array, if such a period is provided.

42. An arrangement as claimed in claim 38, in which each shiftable wavelength filter array comprises an electromechanical control element, which effects the shifting.

43. An arrangement as claimed in claim 2, in which the diffuse illuminator in the second mode of operation comprises an optically scattering foil arranged between the wavelength filter array and the light guide.

44. An arrangement as claimed in claim 43, in which switching into the first mode of operation is accomplished by removing the foil between the wavelength filter array and the light guide.

45. An arrangement as claimed in claim 43, in which the foil has electrophoretic, properties which cause it to be optically scattering in the second mode of operation and transparent to light in the first mode of operation, the switching between the second and first modes being accomplished by influencing the electrophoretic properties.

46. An arrangement as claimed in claim 24, in which the wavelength filter array comprises an electrophoretic component provided with a control device, in which the opaque filter elements are switched to absorb light in the first mode of operation and to reflect light in the second mode of operation.

47. An arrangement for displaying images of a scene or object,
comprising an image display device comprising a multitude of light-transmitting image rendering elements, arranged in a raster of rows and/or columns and on which bits of image information from several perspective views of the scene or object can be displayed,
and comprising a plane, controllable wavelength filter array, which is arranged behind the image display device, and which consists of a multitude of filter elements arranged in rows and/or columns, part of which are transparent to light of specified wavelength ranges,
and comprising a planar light source arranged behind the wavelength filter array,
in which, in a first mode of operation, a remaining part of the filter elements are controlled to be opaque to light, light emitted by the light source reaches the observer by passing through at least part of the light-transmitting filter elements and subsequently through a correlated part of the image rendering elements of the image display device, so that the scene or object is seen by the observer in three dimensions, and in which
the wavelength filter array is an electrophoretic component and, in a second mode of operation, the remaining part of the filter elements are controlled to be transparent to light, so that the scene or object is seen by the observer in two dimensions.

48. An arrangement as claimed in claim 1, in which, in the first mode of operation providing at least partially three-dimensional display, either eye of the observer predominantly, but not exclusively sees a particular selection of the displayed bits of information from several perspective views of the scene or object, so that the observer has a spatial impression.

49. An arrangement as claimed in claim 21, in which, in the first mode of operation providing at least partially three-dimensional display, either eye of the observer predominantly, but not exclusively sees a particular selection of the displayed bits of information from several perspective views of the scene or object, so that the observer has a spatial impression.

50. An arrangement as claimed in claim 38, in which, in the first mode of operation providing at least partially three-dimensional display, either eye of the observer predominantly, but not exclusively sees a particular selection of the displayed bits of information from several perspective views of the scene or object, so that the observer has a spatial impression.

51. An arrangement as claimed in claim 47, in which, in the first mode of operation providing at least partially three-dimensional display, either eye of the observer predominantly, but not exclusively sees a particular selection of the displayed bits of information from several perspective views of the scene or object, so that the observer has a spatial impression.

52. An arrangement as claimed in claim 35, in which the liquid crystal layer has a cholesteric-nematic transition.
